(19) United States
(12) Patent Application Publication
(10) Pub. No.: US 2026/0369893 A1
(43) Pub. Date: Nov. 19, 2026

(54) PHASED ARRAY ANTENNA WITH FOLDED METAL RADIATING ELEMENTS

(71) Applicant: The MITRE Corporation, McLean, VA (US)

(72) Inventors: Matthew Anthony RYDER, Chelmsford, MA (US); Mohamed Wajih ELSALLAL, Acton, MA (US); Jeffrey Alan MALONEY, Norwood, MA (US); Jasmine Alexandra Mirim LEVINE, Cambridge, MA (US)

(73) Assignee: The MITRE Corporation, McLean, VA (US)

(21) Appl. No.: 19/675,061

(22) Filed: May 12, 2026

Related U.S. Application Data
(60) Provisional application No. 63/804,982, filed on May 13, 2025.

(51) Int. Cl. H01Q 21/00

(52) U.S. Cl. CPC H01Q 21/0087

(57) ABSTRACT

A phased array antenna that includes a base plate and at least one radiating element projecting outwardly from the base plate and that includes a folded metal member. A folded metal member may be a signal member of a radiating element that is formed by folding metal. Signal members may be electrically connected to signal feed lines. A folded metal member may alternatively be a ground member of a radiating element that is also formed by folding metal. Ground members may be electrically connected to ground. A phased array antenna may include a radiating element formed from a first folded metal member that is a signal member and a second folded metal member that is a ground member or signal member. By exciting the radiating element to generate a voltage differential between the first folded metal member and the second folded metal member, a signal for transmission may be generated.

### CROSS REFERENCE TO RELATED APPLICATIONS

This application claims the benefit of U.S. Provisional Patent Application No. 63/804,982, filed May 13, 2025, the entire contents of which are incorporated herein by reference.

### FIELD

This application relates generally to antennas, and more specifically to phased array antennas.

### BACKGROUND

There are increasing demands for phased array antennas tailored for various applications, such as satellite communications (SATCOM), radar, remote sensing, direction finding, and other systems. Demands include more flexibility in antenna configuration and functionality at reduced cost with considerations to limited space, weight, and power consumption (SWaP) on modern military and commercial platforms.

A phased array antenna is an array of antenna elements in which the phases of respective signals feeding the antenna elements are set in such a way that the effective radiation pattern of the array is reinforced in a desired direction and suppressed in undesired directions, thus forming a beam. The relative amplitudes of constructive and destructive interference effects among the signals radiated by the individual elements determine the effective radiation pattern of the phased array. The number of antenna elements in a phased array antenna is often dependent on the required gain of a particular application and can range from isotropic to highly directive level. Conventional phased array antennas are often costly to manufacture, not only financially, but also in terms of time, infrastructure, and resources, and may have a weight considered excessive for some modern military and commercial applications.

### SUMMARY

Disclosed herein are phased array antennas that include radiating elements formed of folded metal members. A folded metal member may be, for example, a signal member of a radiating element that is formed, at least in part, by folding metal. Signal members may be electrically connected to signal feed lines and configured to transmit or receive signals. A folded metal member may alternatively be, for example, a ground member of a radiating element that is also formed, at least in part, by folding metal. Ground members may be electrically connected to ground, for instance, via a base plate of a phased array antenna or via a ground line of a Printed Circuit Board (PCB).

In some examples, a phased array antenna may include a radiating element formed from a first folded metal member that is a signal member and a second folded metal member that is a ground member. By exciting the radiating element to generate a voltage differential between the first folded metal member (e.g., signal member) and the second folded metal member (e.g., ground member), a signal for transmission may be generated. In other examples, a phased array antenna may include a radiating element formed from a first folded metal member that is a signal member and a second folded metal member that is another signal member, thus forming a differential phased array antenna. The first and second folded metal members (e.g., pair of signal members) may generate a single signal for transmission. The folded metal members may be formed from sheet metal and may be folded into any geometry, enabling efficient and cost-effective manufacturability of phased array antennas having desired transmission capabilities described above.

According to an aspect, an exemplary phased array antenna comprises: a base plate; and at least one radiating element projecting outwardly from the base plate and comprising a folded metal member.

Optionally, at least one fold of the folded metal member extends orthogonally to the base plate.

Optionally, at least one fold of the folded metal member extends parallel to the base plate.

Optionally, the phased array antenna comprises a conductive element projecting outwardly from the base plate and configured to capacitively couple to the folded metal member.

Optionally, a capacitive coupling portion of the conductive element has a shape that corresponds to a shape of a capacitive coupling portion of the folded metal member and is spaced apart from the capacitive coupling portion of the folded metal member by a gap.

Optionally, at least one surface of the capacitive coupling portion of the folded metal member is parallel to at least one surface of the capacitive coupling portion of the conductive element.

Optionally, the folded metal member is electrically isolated from the base plate.

Optionally, the folded metal member comprises a connecting portion that extends within an aperture in the base plate and is configured to electrically connect to a signal line.

Optionally, the folded metal member is a first folded metal member and the first radiating element comprises a second folded metal member spaced apart from the first folded metal member.

Optionally, the second folded metal member is electrically connected to the base plate.

Optionally, a second radiating element projecting outwardly from the base plate and oriented orthogonally to the first radiating element.

Optionally, the first folded metal member comprises: a first projecting portion extending from the base plate; a second portion extending parallel to the first projecting portion and spaced apart from a first portion; and a connecting portion that joins the first projecting portion and the second projecting portion, the connecting portion comprising at least one fold.

Optionally, the connecting portion extends parallel to the base plate.

Optionally, the connecting portion extends orthogonally to the base plate.

Optionally, the connecting portion forms an arcuate shape.

Optionally, the connecting portion is orthogonal to the first projecting portion and the second projecting portion.

Optionally, the phased array antenna comprises a support structure configured to structurally support the folded metal member.

Optionally, the support structure comprises a plurality of support ribs configured to support the folded metal member.

According to an aspect, a method of assembling a phased array antenna comprises folding a metal member along at least one fold; and mounting the first metal member to a base plate of the phased array antenna.

Optionally, the method comprises folding the metal member along at least one additional fold to form a capacitive coupling portion.

Optionally, the method comprises folding the metal member along at least one additional fold to form a mounting portion; and inserting the mounting portion through the aperture in the base plate to connect the mounting portion to the feed line.

Optionally, the method comprises folding a second metal member along at least one fold; and mounting the second metal member to the base plate, wherein the first metal member and the second metal member form a radiating element.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE DRAWINGS

FIG. 1A illustrates a phased array antenna with a dual-polarized configuration according to some examples.

FIG. 1B illustrates a unit cell of a phased array antenna according to some examples.

FIG. 2A illustrates a first exemplary three-dimensional (3D) view of a phased array antenna according to some examples.

FIG. 2B illustrates mounting portions of a radiating element of a phased array antenna according to some examples.

FIG. 2C illustrates a first top view of a phased array antenna according to some examples.

FIG. 2D illustrates a first view of a capacitive coupling portion of a conductive element and a capacitive coupling portion of a folded metal member according to some examples.

FIG. 3A illustrates a first two-dimensional (2D) view of an unfolded radiating element including a first unfolded metal member and a second unfolded metal member according to some examples.

FIG. 3B illustrates a first 2D side-view of at least one folded metal member according to some examples.

FIG. 4A illustrates a second 2D view of an unfolded radiating element including a first unfolded metal member and a second unfolded metal member according to some examples.

FIG. 4B illustrates a second 2D side-view of at least one folded metal member according to some examples.

FIG. 5 illustrates a third 2D view of an unfolded radiating element including a first unfolded metal member and a second unfolded metal member according to some examples.

FIG. 6A illustrates a second exemplary 3D view of a phased array antenna according to some examples.

FIG. 6B illustrates a second view of mounting portions of a radiating element of a phased array antenna according to some examples.

FIG. 6C illustrates a second top view of a phased array antenna according to some examples.

FIG. 7A illustrates a third exemplary 3D view of a phased array antenna according to some examples.

FIG. 7B illustrates a view of capacitive coupling portions of a conductive element and capacitive coupling portions of folded metal members according to some examples.

FIG. 8A illustrates a first exemplary view of a first folded metal member and a second folded metal member electrically connected to a printed circuit board (PCB) according to some examples.

FIG. 8B illustrates a second exemplary view of a first folded metal member and a second folded metal member electrically connected to a PCB according to some examples.

FIG. 9A illustrates a phased array antenna including a first solid metal member and a second solid metal member according to some examples.

FIG. 9B is a first plot of the electrical performance of a phased array antenna according to some examples.

FIG. 9C illustrates a phased array antenna including a first folded metal member and second folded metal member according to some examples.

FIG. 9D is a second plot of the electrical performance of a phased array antenna according to some examples.

FIG. 10A illustrates a first view of a support structure and support ribs configured to structurally support a radiating element according to some examples.

FIG. 10B illustrates a second view of the support structure of FIG. 10A and support ribs configured to structurally support a radiating element according to some examples.

FIG. 10C illustrates a section view of the support structure of FIG. 10A according to some examples.

FIG. 11 illustrates an exemplary support structure configured to structurally support at least one radiating element and minimize vibrations of the at least one radiating element during its operation at the designed operation frequency range, according to some examples.

FIG. 12A illustrates an exemplary support structure configured to structurally support at least one radiating element with protruding elements that create a stand-off distance between the at least one radiating element and a surface of the support structure, according to some examples.

FIG. 12B illustrates aspects of at least one radiating element sandwiched between a first portion and a second portion of a support structure, according to some examples.

FIG. 13 illustrates an exemplary method to assemble a phased array antenna according to some examples.

### DETAILED DESCRIPTION

Disclosed herein are examples of phased array antennas that include radiating elements that are formed of folded metal members. The folded metal members form the signal and/or ground members of the radiating elements. For example, the radiating elements may be formed from a first folded metal member that is a signal member and a second folded metal member that is a ground member or a second signal member. A signal beam may be generated by exciting the radiating element to generate a voltage differential between the first and second folded metal member. The folded metal member forming a signal member of a radiating element may be electrically connected to a signal feed line and configured to transmit and receive signals. A folded metal member forming a ground member of a radiating element may provide an electrical path to ground, for instance, via a base plate of a phased array antenna or a ground line of a PCB.

A folded metal member may be formed by folding a metal sheet at one or more folds. The folded metal member may include projecting portions that extend parallel to one another on either side of the at least one fold. The projecting portions project outwardly from a base plate of the phased array antenna and are spaced apart from one another. A connecting portion may connect the projecting portions and may include the at least one fold. The connecting portion may extend parallel to the base plate, orthogonally to the base plate, or any other direction relative to the base plate.

A folded metal member may be folded along at least one additional fold to form a capacitive coupling portion configured to capacitively couple to an adjacent capacitive coupling portion on a conductive element or another folded metal member. The folded metal member may be folded along at least one additional fold to form a mounting portion, and the mounting portion may be inserted through an aperture in a base plate to connect the mounting portion to a signal feed line. Any number of radiating elements may be thus formed and assembled into an antenna array of a phased array antenna.

Compared to radiating elements formed from casting, milling, or additive manufacturing, radiating elements formed from the folded metal members may be relatively light-weight and may provide similar electrical performance (e.g., signal loss transmission, etc.). Additionally, radiating elements formed from the folded metal members may provide similar surface area for capacitive coupling to adjacent conductive elements compared to radiating elements formed from casting, milling, or additive manufacturing. Furthermore, manufacturing of radiating elements formed from folded metal members may be more easily scalable and cost-effective because the folded metal members are assembled from sheet metal members, which may be fabricated via subtractive manufacturing of cheap sheet metal. Thus, phased array antennas that include radiating elements formed of folded metal members enable a more lightweight, cost-effective, and scalable design without sacrificing performance.

The following description sets forth exemplary systems, parameters, and the like. It should be recognized, however, that such description is not intended as a limitation on the scope of the present disclosure but is instead provided as a description of exemplary examples.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described examples. The first graphical representation and the second graphical representation are both graphical representations, but they are not the same graphical representation.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

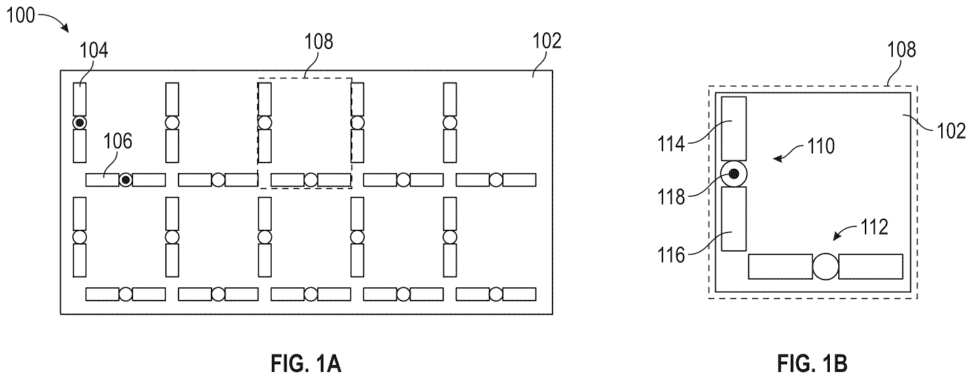

FIG. 1A illustrates aspects of an exemplary phased array antenna 100 with a dual polarized configuration. The dual polarized configuration includes at least one radiating element 104 oriented in a first direction and at least one radiating element 106 oriented in a second direction. Radiating elements 104 and radiating elements 106 project outwardly from a base plate 102. As discussed further below, the radiating elements 104 and 106 may include folded metal members.

Phased array antenna 100 is a 4×5 array of unit cells 108. According to certain examples, phased array antenna 100 can be scaled up or down to operate over a specified frequency range. More unit cells can be included, or unit cells can be removed, to meet other specific design requirements such as antenna gain. According to certain examples, modular arrays of a predefined size may be combined into a desired configuration to create an antenna array to meet the required performance. For example, a module may include the 4×5 array of radiating elements 104 and 106. A particular antenna application requiring 160 radiating elements 104 and 106 can be built using eight modules fitted together (thus, providing the 160 radiating elements 104 and 106). This modular design allows for antenna arrays to be tailored to specific design requirements at a lower cost.

In some examples, the radiating elements 104 are of a different size, shape, and spacing compared to radiating elements 106. However, in other examples, the radiating elements 104 may be of the same size, shape, and spacing as radiating elements 106. Phased array antenna 100, according to some examples, may include only single polarized radiating elements (e.g., only rows of radiating elements 104). According to some examples, the spacing of one set of radiating elements (e.g., radiating elements 106) is different from the spacing of the other set of radiating elements (e.g., radiating elements 104). According to some examples, the radiating elements spacing within a row may not be uniform. For example, the spacing between first and second radiating elements within a row may be different than the spacing between the second and third elements.

As shown in FIG. 1B, a unit cell 108 includes a radiating element 110 oriented in a first direction and a radiating element 112 oriented in a second direction that is orthogonal to the first direction, such that radiating element 110 is substantially orthogonal to radiating element 112; the radiating element 110 may one of be the vertical elements 104 in FIG. 1A, and the radiating element 112 may be one of the horizontal elements 106 in FIG. 1A. This orthogonal orientation results in each unit cell 108 being able to generate orthogonally directed electric field polarizations. That is, by disposing one set of elements (e.g., vertical elements 104 in FIG. 1A) in one direction and disposing a second set of elements (e.g., horizontal elements 106 in FIG. 1A) in the orthogonal direction, the phased array antenna 100 can generate signals having any polarization.

In FIG. 1A, unit cells 108 are disposed in a regular pattern, which here corresponds to a square grid pattern. Those of ordinary skill in the art would appreciate that unit cells 108 need not all be disposed in a regular pattern. In some applications, it may be desirable to modify the orientation of unit cells 108 and/or modify the orientation of the radiating elements 110 and 112 of the unit cell 108 on the base plate 102. Thus, although shown as a square grid pattern of unit cells 108, it would be appreciated by those or ordinary skill in the art that phased array antenna 100 could include but it not limited to a rectangular or triangular pattern of unit cells 108 and that each of the unit cells can be rotated at different angles along the pattern. In some examples, radiating element 110 or 112 of unit cell 108 could be replaced by another structure (e.g., a differently shaped radiating element, a wall, etc.). In some examples, radiating element 110 (112) is the same as radiating element 104 (106) in FIG. 1A.

In some examples, the radiating element 110 includes a signal member 114 and a ground member 116. A signal beam is generated by exciting radiating element 110, i.e., by generating a voltage differential between signal member 114 and ground member 116. The generated signal beam has a direction along a centerline 118 of radiating element 110, perpendicular to the base plate 102. The centerline 118 is the phase center of radiating element 110. A signal beam generated by exciting radiating element 110 has a phase center midway between its respective signal 114 and ground 116 members. In some examples, as shown in FIG. 1A, the phase centers of radiating elements 104 are not co-located with the phase centers of radiating elements 106. In other examples, the phase centers of radiating elements 104 are co-located with the phase centers of radiating elements 106.

In some examples, radiating elements are shaped to capacitively couple with adjacent radiating elements oriented in the same direction. For instance, a signal member may capacitively couple directly to an adjacent signal member or an adjacent ground member. This capacitance can be used to improve the impedance matching of the antenna. In some examples, a radiating element oriented in a first direction and a radiating element oriented in a second direction are positioned such that there is some capacitive coupling between the respective radiating elements. Capacitive coupling may be achieved between two radiating elements directly adjacent to one another. In some examples, radiating elements may include capacitive coupling portions configured to capacitively couple to capacitive coupling portions of other conductive elements connected to the base plate 102 (e.g., grounded pillars, milled sheets/walls, etc.) that are adjacent to the radiating elements.

Base plate 102 may be formed from one or more conductive materials, such as metals like aluminum, copper, gold, silver, beryllium copper, brass, and various steel alloys. In some examples, base plate 216 is formed from a non-conductive material such as various plastics, for example Acrylonitrile butadiene styrene (ABS), Nylon, Polyamides (PA), Polybutylene terephthalate (PBT), Polycarbonates (PC), Polyetheretherketone (PEEK), Polyetherketone (PEK), Polyethylene terephthalate (PET), Polyimides, Polyoxymethylene plastic (POM/Acetal), Polyphenylene sulfide (PPS), Polyphenylene oxide (PPO), Polysulphone (PSU), Polytetrafluoroethylene (PTFE/Teflon), or Ultra-high-molecular-weight polyethylene (UHMWPE/UHMW), that is cladded with a conductive material, such as metals like gold, silver, copper, or nickel. According to some examples, base plate 102 is a solid block of material with holes, slots, or cut-outs to accommodate various elements, for example signal members 114, ground members 116, and conductive elements, on the top (radiating) side and connectors on the bottom side to connect feed lines. In other examples, base plate 102 includes cutouts to reduce weight.

In some examples, base plate 102 may be manufactured with any subtractive or additive manufacturing method, for example machined, cast, or molded. In some examples, holes or cut-outs in base plate 102 may be created by any subtractive or additive manufacturing method, for example, milling, drilling, wire EDM, or formed into the case or mold used to create base plate 102. Base plate 102 can provide structural support for each radiating element and provide overall structural support for the phased array antenna 100. Base plate 102 may be of various thicknesses depending on the design requirements of a particular application. For example, a phased array antenna 100 of thousands of radiating elements may include a base plate that is thicker than the base plate of a phased array antenna 100 of a few hundred elements in order to provide the required structural rigidity for the larger dimensioned array.

The phased array antenna 100 may have a designed operational frequency range, for example the very high frequency (VHF) range, the ultra-high frequency (UHF) range, or another frequency range. The sizing and positioning of radiating elements can be designed to effectuate these desired frequencies and ranges. For example, the spacing between a portion of a first radiating element and a portion of the next radiating element along the same axis may be equal to or less than about one-half a wavelength, λ, of a desired frequency (e.g., highest design frequency in the operational frequency range). According to some examples, the separation may be less than 1λ, less than 0.75λ, less than 0.66λ, less than 0.33λ, or less than 0.25λ. According to some examples, the spacing may be equal to or greater than 0.25λ, equal to or greater than 0.5λ, equal to or greater than 0.66λ, equal to or greater than 0.75λ, or equal to or greater than 1λ. The thickness of the at least one piece of sheet metal used in the folded sheet metal radiating element described herein may also be designed to affect the operational frequency range.

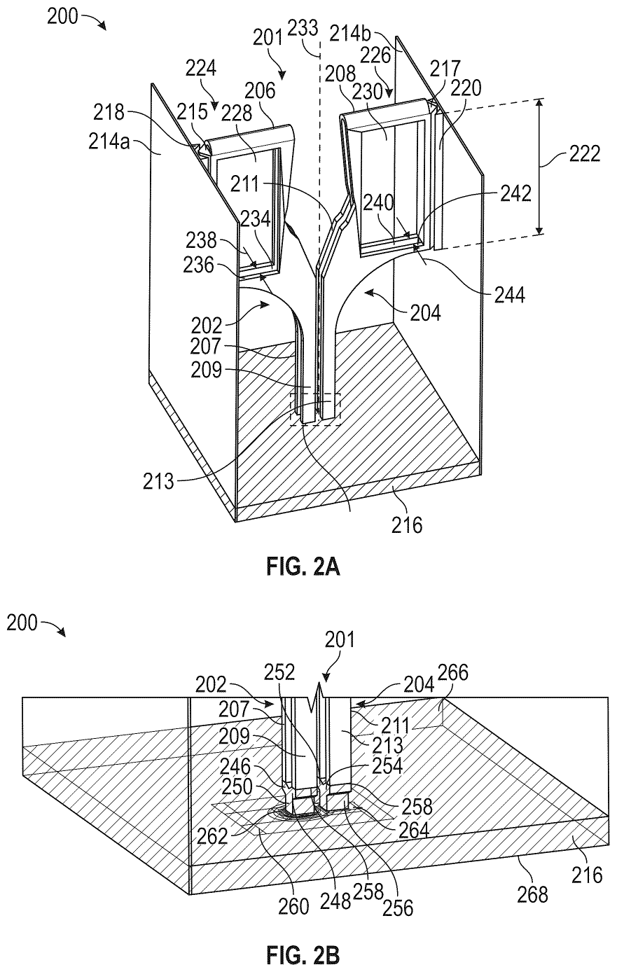

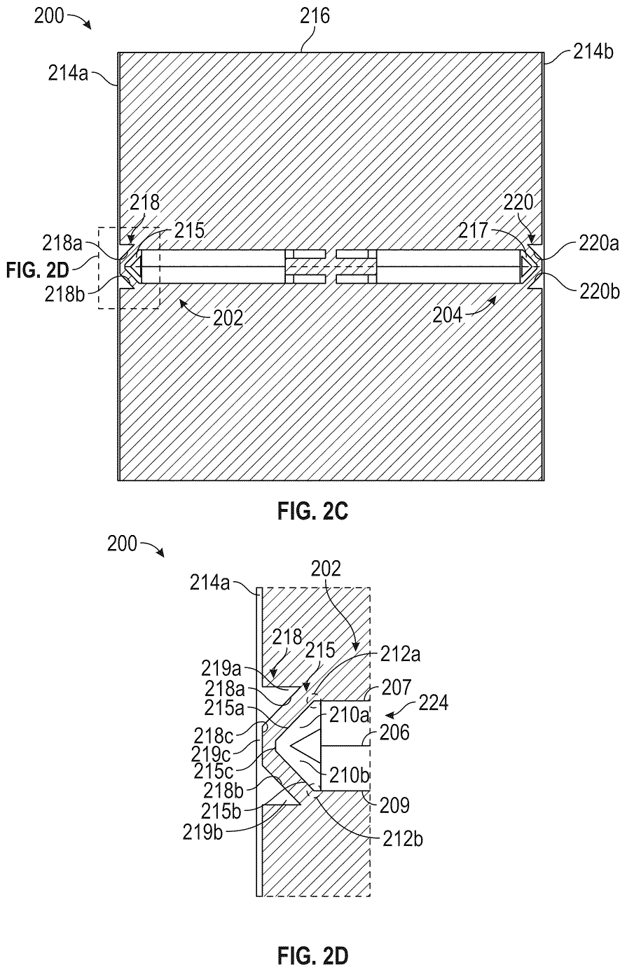

As discussed with reference to FIG. 1A, the radiating elements (e.g., radiating elements 104 and 106) of the phased array antennas disclosed herein may be formed of folded metal members. The folded metal members may be, for example, a signal member or a ground member of a radiating element that is formed, at least in part, by folding metal (e.g., sheet metal). FIGS. 2A-2D below illustrate exemplary aspects of a phased array antenna 200 that includes a radiating element 201 formed by folding a first metal member into a first folded metal member 202 and by folding a second metal member into a second folded metal member 204. The radiating element 201 can be used for any of the radiating elements disclosed herein, including radiating elements 104, 106, 110, and/or 112 of FIGS. 1A-1B. For instance, the first folded metal member 202 and the second folded metal member 204 may be used for folded metal members 114 and 116, respectively, of FIG. 1B.

FIG. 2A illustrates aspects of a phased array antenna 200 that may be included in the phased array antenna 100 of FIG. 1A. The phased array antenna 200 includes a base plate 216 and at least one radiating element 201 projecting outwardly from the base plate 216. The radiating element 201 may include a first folded metal member 202 spaced apart from a second folded metal member 204. The first folded metal member 202 may be a signal member electrically connected to a signal feed line and configured to transmit and receive signals. The second folded metal member 204 may be a ground member configured to provide an electrical path to ground, for instance, via the base plate 216 or via another ground line. By exciting the radiating element 201 to generate a voltage differential between the first folded metal member 202 (e.g., the signal member) and the second folded metal member 204 (e.g., the ground member), a signal beam for transmission can be generated. While the exemplary illustrations disclosed herein depict a signal member and a ground member forming a radiating element, a person of skill in the art would understand that, the first folded metal member 202 may be a first signal member connected to a first feed line and the second folded metal member 204 may be a second signal member connected to a second feed line, thus forming a differential phased array antenna, for instance, as described in U.S. patent application Ser. No. 18/538,820, filed Dec. 13, 2023 and titled “LOW-PROFILE WIDEBAND ANTENNA ARRAY CONFIGURED FOR CONNECTORLESS MOUNTING,” which is incorporated herein by reference in its entirety. In such examples, the first signal feed line can provide a signal to the first folded metal member (e.g., first signal member) and the second signal feed line can provide a signal to the second folded metal member (e.g., second signal member). Together, the first and second folded metal members (or first and second signal members, respectively) may form a differential pair, and the differential pair formed of the first folded metal member 202 (e.g., first signal member) and the second folded metal member 204 (e.g., second signal member) may generate a signal for transmission.

The first folded metal member 202 may be formed by folding a metal member (e.g., a sheet metal member) along at least one fold. The first folded metal member 202 may include at least one fold 206. The fold 206 may extend parallel to the base plate 216. A connecting portion 224 may include the fold 206, or it may be formed by part of the fold 206, and the connecting portion 224 may connect a first projecting portion 207 and a second projecting portion 209. The first projecting portion 207 and the second projecting portion 209 may project outwardly from the base plate 216. The first projecting portion 207 may include a surface 234 positioned adjacent to and facing a surface 236 of the second projecting portion 209. The first projecting portion 207 and the second projecting portion 209 may be spaced apart by a distance 238.

The second folded metal member 204 may also be formed by folding a sheet metal member along at least one fold. The second folded metal member 204 may include at least one fold 208. Fold 208 may extend parallel to the base plate 216 and may be aligned with fold 206 of the first folded metal member 202. A connecting portion 226 may include the fold 208, or it may be formed by part of the fold 208, and the connecting portion 226 may connect a first projecting portion 211 and a second projecting portion 213. The first projecting portion 211 and the second projecting portion 213 may project outwardly from the base plate 216. The first projecting portion 211 may include a surface 240 positioned adjacent to and facing a surface 242 of the second projecting portion 213. The first projecting portion 211 and the second projecting portion 213 may be spaced apart by a distance 244. The distance 244 may be the same as the distance 238. The distance 238 and the distance 244 may be associated with the operational frequency range and/or the electrical performance of the phased array antenna 200. In some examples, the second folded metal member 204 is symmetrical to the first folded metal member 202 about axis 233. In some examples, the second folded metal member 204 is not symmetrical to the first folded metal member 202 about axis 233. In some examples, the second folded metal member 204 may have different characteristics than the first folded metal member 202, for example the second folded metal member 204 may have a different size, outline (e.g., edges), fold, etc. FIG. 2B illustrates additional detail of the electrical connection of the first folded metal member 202 (e.g., the signal member) to a signal feed line 262 on PCB 260 and the second folded metal member 204 (e.g., the ground member) to a ground line 264 on PCB 260. The first projecting portion 207 of the first folded metal member 202 may include a post 246 and the second projecting portion 209 may include post 248. Post 246 of the first projecting portion 207 and post 248 of the second projecting portion 209 may be folded together to form a mounting portion 250. In some examples, post 246 and post 248 may be folded together and then soldered to form the mounting portion 250. In other examples, the mounting portion 250 may be an attachment mechanically and electrically connected (e.g., via soldering, friction fitting, welding, etc.) to post 246 and post 248. The mounting portion 250 (and/or post 246 and post 248) of the first folded metal member 202 (e.g., the signal member) may be electrically isolated from the base plate 216 and may extend via an aperture 258 from a first side 266 of the base plate 216 to a second side 268 of the base plate 216 to electrically connect to the signal feedline 262. The signal feed line 262 may be a portion of the PCB 260, and the PCB 260 may be positioned on the second side 268 of the base plate 216.

Similarly, the first projecting portion 211 of the second folded metal member 204 may include a post 252 and the second projecting portion 213 may include post 254. Post 252 of the first projecting portion 211 and post 254 of the second projecting portion 213 may be folded together to form a mounting portion 256. In some examples, post 252 and post 254 may be folded together and then soldered to form the mounting portion 256. In other examples, the mounting portion 256 may be an attachment mechanically and electrically connected (e.g., via soldering, friction fitting, welding, etc.) to post 252 and post 254. The mounting portion 256 of the second folded metal member 204 (e.g., the ground member) may extend via an aperture 258 from a first side 266 of the base plate 216 to a second side 268 of the base plate 216 and may be electrically connected to ground, for example via base plate 216 or via a ground line 264. The ground line 264 may be a portion of the PCB 260, and the PCB 260 may be positioned on the second side 268 of the base plate 216.

Referring back to FIG. 2A, the space (e.g., including the space defined by distance 238) between the first projecting portion 207 and the second projecting portion 209 of the first folded metal member 202 may be filled with any material transparent in the operational frequency range (e.g., any material that passes light with a frequency in the operational frequency range), for example, ROHACELL foam. Filling the distance 238 with a transparent material may improve the mechanical stability of the first folded metal member 202. Similarly, the space (e.g., including the space defined by distance 244) between the first projecting portion 211 and the second projecting portion 213 of the second folded metal member 204 may be filled with a material transparent in the operational frequency range. Filling the distance 244 with a transparent material may similarly improve the mechanical stability of the second folded metal member 204.

The first folded metal member 202 may have a cutout 228, and the second folded metal member 204 may have a cutout 230. In some examples, the cutout 228 is a hole of any geometry through the first folded metal member 202. The cutout 228 may be fabricated before or after the sheet metal member is folded to form the first folded metal member 202. In some examples, the cutout 230 is a hole of any geometry through the second folded metal member 204. The cutout 230 may be fabricated before or after the sheet metal member is folded to form the second folded metal member 204. Cutouts 228 and 230 may reduce the weight of the first 202 and second folded metal member 204, respectively, and the cutouts 228 and 230 may be any shape and/or pattern, such as a polygon, a circle, an oval, an ellipsoid, or a lattice. In some examples, cutout 228 is a different shape or pattern than cutout 230, for example cutout 228 is a lattice and cutout 230 is a circle. In some examples, as depicted in FIG. 2A, cutout 228 and cutout 230 are the same, or nearly the same shape or pattern. Cutouts 228 and 230 may be fabricated via any subtractive manufacturing method, including the methods described herein. Additionally, cutouts 228 and 230 may be associated with (e.g., impact) the electrical performance of the phased array antenna 200. In some examples, at least one additional element, for example a dielectric, a conductor, and/or a magnet, is added to cutout 228 and/or cutout 230. The at least one additional element added to cutout 228 may be the same, or different, than the at least one additional element added to cutout 230. The at least one additional element added to cutout 228 and/or cutout 230 may alter the electrical performance of the phased array antenna 200.

In some examples, the first folded metal member 202 includes a capacitive coupling portion 215, and the second folded metal member 204 includes a capacitive coupling portion 217, and the capacitive coupling portions 215 and 217 may capacitively couple the respective folded metal member to an adjacent conductive element. FIG. 2C illustrates aspects of the capacitive coupling portions 215 and 217. The capacitive coupling portion 215 of the first folded metal member 202 may include at least one surface that capacitively couples to at least one surface of another conductive member, for example surface 218a and surface 218b, of a capacitive coupling portion 218 of a conductive element 214a. Similarly, the capacitive coupling portion 217 of the second folded metal member 204 may include at least one surface that capacitively couples to at least one surface of another conductive member, for example surface 220a and surface 220b, of a capacitive coupling portion 220 of a conductive element 214b.

As described above, the capacitive coupling portion 215 of the first folded metal member 202 may include at least one surface that capacitively couples to at least one surface of the capacitive coupling portion 218 of the conductive element 214a. FIG. 2D illustrates aspects of the capacitive coupling of the capacitive coupling portions 215 and 218. In some examples, the capacitive coupling portion 215 includes at least one surface, for example surface 215a, of the first folded metal member 202. In some examples, the capacitive coupling portion 215 includes a plurality of surfaces, including surface 215b and surface 215c, of the folded metal member 202. Surface 215a may be included on a conductive tab 210a of the first projecting portion 207 of the folded metal member 202. Conductive tab 210a may be folded toward the second projecting portion 209 of folded metal member 202 along a fold 212a. Surface 215b may be included on a conductive tab 210b of the second projecting portion 209. Conductive tab 210b may be folded toward the first projecting portion 207 along another fold 212b. The conductive tab 210a may be electrically connected to conductive tab 210b to form the surface 215c of the capacitive coupling portion 215. In some examples, the conductive tabs 210a and 210b are integral to their respective projecting portion. In some examples, the capacitive coupling portion 215 is or includes conductive members electrically joined and attached to the first folded metal member 202 (e.g., via welding, conductive adhesive, soldering, etc.). The conductive members may be defined by a plurality of surfaces, for examples the surfaces 215a, 215b, and 215c, and they may be any metal, including the examples described herein.

The surface 215a, the surface 215b, and the surface 215c of the capacitive coupling portion 215 of the folded metal member 202 may be positioned adjacent to and facing corresponding surfaces 218a, 218b, and 218c of the capacitive coupling portion 218 of the conductive element 214a. In some examples, the surfaces 215a, 215b, and 215c are spaced apart by a gap from the corresponding surfaces 218a, 218b, and 218c. The capacitive coupling portion 218 may include a conductive portion 219a, a conductive portion 219b, and a conductive portion 219c. Surface 218a may be included on the conductive portion 219a, and surface 218a may be adjacent to and facing surface 215a of the capacitive coupling portion 215. Surface 218b may be included on the conductive portion 219b, and surface 218b may be adjacent to and facing surface 215b of the capacitive coupling portion 215. Surface 218c may be included on the conductive portion 219c, and surface 218c may be adjacent to and facing surface 215c of the capacitive coupling portion 215. The conductive portions 219a, 219b, and 219c may be formed from any metal, including the examples described herein, and the conductive portions 219a, 219b, and 219c may be any shape such that the surfaces 218a, 218b, and 218c, respectively, may be adjacent to and facing the corresponding surfaces 215a, 215b, and 215c of the capacitive coupling portion 215. In some examples, the conductive portions 219a, 219b, and 219c are integral to the conductive element 214a. In some examples, the conductive portions 219a, 219b, and 219c are formed separately from the conductive element 214a, using any subtractive or additive manufacturing method described herein, and are then attached to the conductive element 214a, using any attachment method described herein. Additionally, a person of skill in the art would appreciate that the capacitive coupling portion 217 of the second folded metal member 204 and the capacitive coupling portion 220 of the conductive element 214b may be symmetric to the capacitive coupling portion 215 and capacitive coupling portion 218, respectively, such that the above description may be similarly applied to capacitive coupling portions 217 and 220.

Referring back to FIG. 2A, the conductive elements 214a and 214b may separate (e.g., be positioned between) adjacent radiating elements 201. The conductive elements 214a and 214b may eliminate or dampen common mode resonances between adjacent radiating elements 201. The conductive elements 214a and 214b may be formed from at least one piece of sheet metal, and the sheet metal may be any metal, including the examples described herein. While FIG. 2A depicts conductive elements 214a and 214b of rectangular shape, a person of ordinary skill in the art will appreciate that the conductive elements 214a and 214b may be any shape or pattern. In some examples, the conductive elements 214a and 214b have a height that is greater than or equal to the height of the radiating element 201. In some examples, the conductive elements 214a and 214b have a height that is less than or equal to the height of the radiating element 201. The conductive elements 214a and 214b may have a width that is greater than or equal to the width of the base plate 216. In some examples, the conductive elements 214a and 214b may have a width that is less than or equal to the width of the base plate 216. In some examples, the operational frequency range and/or electrical performance of the phased array antenna 200 is associated with the width and/or the height of the conductive elements 214a and 214b. In some examples, the capacitive coupling portion 218 of conductive element 214a and the capacitive coupling portion 220 of conductive element 214b are integral to the respective conductive elements and are formed by any subtractive manufacturing method. In some examples, capacitive coupling portions 218 and 220 are formed separately from the conductive elements 214a and 214b, respectively, and are then attached to their respective conductive element by any attachment method, for example glueing, soldering, or mechanical fasteners (e.g., screws). The capacitive coupling portion 218 and the capacitive coupling portion 220 of conductive elements 214a and 214b, respectively, may have a length 222.

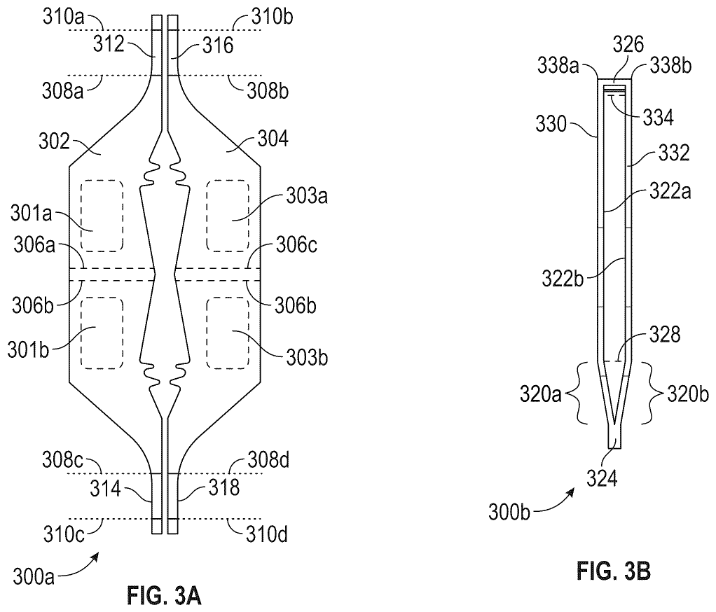

As discussed with reference to FIG. 2A, folded metal members may be formed by folding sheet metal members along at least one fold. FIG. 3A illustrates aspects of an unfolded radiating element 300a that may be used as the radiating element 201 of FIGS. 2A-2D. The unfolded radiating element 300a may include a first sheet metal member 302 that may be folded along at least one fold, thus forming a folded metal member that may be used as the first folded metal member 202 (e.g., signal member) of FIGS. 2A-2D. The unfolded radiating element 300a may also include a second sheet metal member 304 that may be folded along at least one fold, thus forming another folded metal member that may be used as the second folded metal member 204 (e.g., ground member) of FIGS. 2A-2D. In some examples, the first sheet metal member 302 is folded along fold 306a and fold 306b, thus forming a folded metal member. Similarly, the second sheet metal member 304 may be folded along fold 306c and fold 306d, thus forming a second folded metal member. The first sheet metal member 302 and the second sheet metal member 304 may be formed from or include any metal, for example, aluminum, copper, gold, silver, zinc, nickel, and brass. In some examples, the sheet metal member is a first metal that is cladded with a second metal, for example a steel alloy cladded with copper. The first sheet metal member 302 and the second sheet metal member 304 maybe fabricated via any subtractive manufacturing method, including the examples described herein.

The first sheet metal member 302 may include a cutout 301a and a cutout 301b, and the second sheet metal member 304 may include a cutout 303a and a cutout 303b. A cutout may be a hole in the sheet metal member. Cutouts 301a and 301b may be any shape and/or pattern, such as a polygon, a circle, an oval, an ellipsoid, an eye beam, or a lattice. In some examples, cutout 301a is a different shape or pattern than cutout 301b, for example cutout 301a is a lattice and cutout 301b is a circle. Cutout 301a may be the same shape or pattern as cutout 301b. In some examples, cutout 301a and cutout 301b is any size. Cutout 301a may have a different size than cutout 301b. As depicted in FIG. 3A, cutout 301a may be the same size as cutout 301b. Cutouts 301a and 301b may be fabricated by any subtractive manufacturing method, including the methods described herein. Cutouts 303a and 303b may have any of the characteristics described above in reference to cutouts 301a and 201b. In some examples, cutouts 301a, 301b, 303a, and 303b may reduce the weight of the unfolded metal member 302 and the unfolded metal member 304, respectively.

In some examples, the first sheet metal member 302 includes an unfolded post 312 and another unfolded post 314. The unfolded post 312 may be configured to be folded along at least one post fold, for example post fold 308a and/or 310a, thus forming a post, for example post 246 referenced in FIG. 2B. The unfolded post 314 may also be configured to be folded along at least one post fold, for example post fold 308c and/or 310c, thus forming a post, for example post 248 as referenced in FIG. 2B. Similarly, the second sheet metal member 304 may include an unfolded post 316 and an unfolded post 318. The unfolded post 316 may be configured to be folded along at least one post fold, for example post fold 308b and/or 310b, thus forming a post, for example post 252 referenced in FIG. 2B. The unfolded post 318 may also be configured to be folded along at least one post fold, for example post fold 308d and/or 310d, thus forming a post, for example post 254 referenced in FIG. 2B.

The sheet metal members disclosed herein (e.g., sheet metal member 302 and sheet metal member 304) may have a thickness in a range of about 10 mil to 150 mil, for example about 10 mil, 20 mil, 30 mil, 40 mil, 50 mil, 60 mil, 70 mil, 80 mil, 90 mil, 100 mil, 110 mil, 120 mil, 130 mil, 140 mil, and 150 mil. In some examples, the sheet metal members have a thickness that is greater than or equal to 10 mil, 20 mil, 30 mil, 40 mil, 50 mil, 60 mil, 70 mil, 80 mil, 90 mil, 100 mil, 110 mil, 120 mil, 130 mil, 140 mil, and 150 mil. In some examples, the sheet metal members have a thickness that is less than or equal to 10 mil, 20 mil, 30 mil, 40 mil, 50 mil, 60 mil, 70 mil, 80 mil, 90 mil, 100 mil, 110 mil, 120 mil, 130 mil, 140 mil, and 150 mil.

FIG. 3B illustrates a side view of aspects of a folded metal member 300b. The folded metal member 300b may be formed by folding unfolded sheet metal member 302 or unfolded sheet metal member 304 depicted in FIG. 3A. Folded sheet metal member 300b may be used as the first folded metal member 202 (e.g., signal member) or the second folded metal member 204 (e.g., ground member) of the radiating element 201 of FIGS. 2A-2D. The folded metal member 300b may include a connecting portion 326 that connects a first projecting portion 330 to a second projecting portion 332. In some examples, the connection portion 326, or a part of the connecting portion 326, of the folded metal member 300b includes a fold that forms an arcuate shape (e.g., as shown in FIGS. 2A and 2C). In some examples, the connecting portion 326 includes multiple fold axes and multiple corresponding folds. For instance, the connecting portion 326 may include a first 90° fold 338a, and the first 90° fold 338a may be positioned at an edge of the connecting portion 326 where the connecting portion 326 meets the first projecting portion 330. The connecting portion 326 may also include a second 90° fold 338b, and the second 90° 338b may be positioned at another edge of the connecting portion 326, in which the connecting portion 326 meets the second projecting portion 332. The first projecting portion 330 may include a surface 322a positioned adjacent to and facing a surface 322b of the second projecting portion 332. The first projecting portion 330 and the second projecting portion 332 may be spaced apart by a uniform distance along at least a portion of the first projecting portion 330 and the second projecting portion 332, such that distance 334 is the same as distance 328. In some examples, the first projecting portion 330 and the second projecting portion 332 are spaced apart by a non-uniform distance along at least a portion of the first projecting portion 330 and the second projecting portion 332, such that distance 334 is not the same as distance 328.

The first projecting portion 330 may include a post 320a, and the second projecting portion 320b may include a post 320b. The post 320a and the post 320b may folded together to form a mounting portion 324. In some examples, the post 320a and the post 320b are folded together and then soldered to form the mounting portion 324. The post 320a may be formed by folding, along at least one post fold, an unfolded post of a sheet metal member. For example, post 320a may be formed by folding unfolded post 312 along post folds 308a and 310a, as described in reference to FIG. 3A. Post 320b may also be formed by folding, along at least one post fold, another unfolded post of the sheet metal member. For example, post 320b may be formed by folding unfolded post 314 along post folds 308c and 310c. In some examples, post 320a and post 320b have the same, or nearly the same, folds (e.g., shape). In some examples, post 320a and post 320b have different folds (e.g., shape).

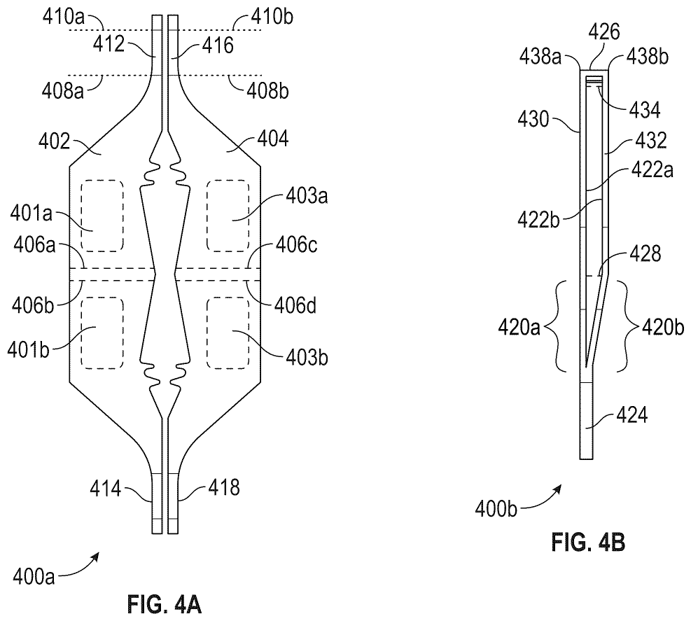

FIG. 4A illustrates aspects of an unfolded radiating element 400a that may be used as the radiating element 201 of FIGS. 2A-2D. The unfolded radiating element 400a may include a first sheet metal member 402 that may be folded along at least one fold, thus forming a folded metal member that may be used as the first folded metal member 202 (e.g., signal member) of FIGS. 2A-2D. The unfolded radiating element 400a may also include a second sheet metal member 404 that may be folded along at least one fold, thus forming a folded metal member that may be used as the second folded metal member 204 (e.g., ground member) of FIGS. 2A-2D. along. In some examples, the first sheet metal member 402 is folded along fold 406a and fold 406b, thus forming a folded metal member. Similarly, the second sheet metal member 404 may folded along fold 406c and fold 406d, thus forming a folded metal member. The first sheet metal member 402 and the second sheet metal member 404 may be any metal, including the examples described herein, and they may be fabricated via any subtractive manufacturing method, including the examples described herein.

The first sheet metal member 402 may include a cutout 401a and a cutout 401b, and the second sheet metal member 404 may include a cutout 403a and a cutout 403b. Cutouts 401a, 401b, 403a, and 403b may have any of the characteristics described above in reference to FIG. 3A. In some examples, the first sheet metal member 402 includes an unfolded post 412 and another unfolded post 414. The unfolded post 412 may be configured to be folded along at least one post fold, for example 408a and/or 410a, thus forming a post, for example post 246 referenced in FIG. 2B. The unfolded post 414 may be configured to remain unfolded. Similarly, the second sheet metal member 404 may include an unfolded post 416 and an unfolded post 418. The unfolded post 416 may be configured to be folded along at least one post fold, for example 408b and/or 410b, thus forming a post, for example post 252 referenced in FIG. 2B. In some examples, the unfolded post 418 may be configured to remain unfolded.

FIG. 4B illustrates a side view of aspects of a folded metal member 400b. The folded metal member 400b may be formed by folding unfolded sheet metal member 402 or unfolded sheet metal member 404 depicted in FIG. 4A. Folded sheet metal member 400b may be used as the first folded metal member 202 (e.g., signal member) or the second 204 folded metal member (e.g., ground member) of the radiating element 201 of FIGS. 2A-2D. The folded metal member 400b may include a connecting portion 426 that connects a first projecting portion 430 to a second projecting portion 432. In some examples, the connection portion 426, or a part of the connecting portion 426, of the folded metal member 400b includes a fold that forms an arcuate shape (e.g., as shown in FIGS. 2A and 2C). In some examples, as shown in FIG. 4B, the connecting portion 426 includes multiple fold axes and multiple corresponding folds. For instance, the connecting portion 426 may include a first 90° 438a, and the first 90° fold 438a may be positioned at an edge of the connecting portion 426 where the connecting portion 426 meets the first projecting portion 430. The connecting portion 426 may also include a second 90° fold 438b, and the second 90° fold 438b may be positioned at another edge of the connecting portion 426, in which the connecting portion 426 meets the second projecting portion 432. The first projecting portion 430 may include a surface 422a positioned adjacent to and facing a surface 422b of the second projecting portion 432. The first projecting portion 430 and the second projecting portion 432 may be spaced apart by a uniform distance along at least a portion of the first projecting portion 430 and the second projecting portion 432, such that distance 434 is the same as distance 428. In some examples, the first projecting portion 430 and the second projecting portion 432 are spaced apart by a non-uniform distance along at least a portion of the first projecting portion 430 and the second projecting portion 432, such that distance 434 is not the same as distance 428.

The first projecting portion 430 may include a post 420a, and the second projecting portion 420b may include a post 420b. The post 420a and the post 420b may be folded together form a mounting portion 424. In some examples, the post 420a and the post 420 are folded together and then soldered to form the mounting portion 424. The post 420a may be formed by not folding an unfolded post of a sheet metal member. For example, post 420a may be formed by not folding unfolded post 414, as described in reference to FIG. 4A. Post 420b may be formed by folding, along at least one post fold, another unfolded post of the sheet metal member. For example, post 420b may be formed by folding unfolded post 412 along post folds 408a and 410a.

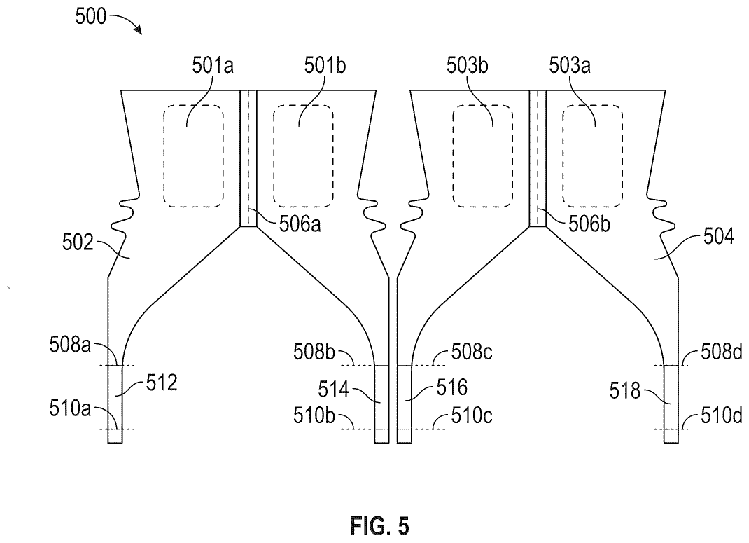

Discussed herein, the radiating elements of phased array antennas may include folded metal members with connecting portions formed by folding the metal members extending parallel to a base plate, orthogonal to a base plate, or any other direction relative to a base plate of the phased array antennas. Folded metal members with connecting portions extending orthogonal to a base plate of the phased array antenna may further reduce the manufacturing complexity associated with assembling a phased array antenna including folded metal members. For instance, due to the geometry of an orthogonally extending connecting portion, a fold of the connecting portion may form at least a portion of a capacitive coupling portion of the folded metal member, which may eliminate the assembling of a capacitive coupling portion via conductive tabs (such as 210a and 210b in FIG. 2D). FIG. 5 illustrates aspects of an unfolded radiating element 500 that may be used to form a radiating element that includes folded metal members with connecting portions extending orthogonal to a base plate of a phased array antenna. The unfolded radiating element 500 may include a first sheet metal member 502 that may be folded along at least one fold, thus forming a folded metal member that may be used as the first folded metal member 202 (e.g., signal member) of FIGS. 2A-2D. The unfolded radiating element 500 may also include a second sheet metal member 504 that may be folded along at least one fold, thus forming a folded metal member that may be used as the second folded metal member 204 (e.g., ground member) of FIGS. 2A-2D. The first sheet metal member 502 may be folded along fold 506a, thus forming a folded metal member. Similarly, the second sheet metal member 504 may folded along fold 506b. In some examples, the first sheet metal member 502 is folded along two folds, thus forming a folded metal member, for example as described in reference to the folded metal member 300b in FIG. 3B or the folded metal member 400b in FIG. 4B. Similarly, the second sheet metal member 504 may be folded along two folds, thus forming a folded metal member, for example as described in reference to the folded metal member 300b in FIG. 3B or the folded metal member 400b in FIG. 4B. The first sheet metal member 502 and the second sheet metal member 504 may be any metal, including the examples described herein, and they may be fabricated via any subtractive manufacturing method, including the examples described herein.

The first sheet metal member 502 may include a cutout 501a and a cutout 501b, and the second sheet metal member 504 may include a cutout 503a and a cutout 503b. Cutouts 501a, 501b, 503a, and 503b may have any of the characteristics described above in reference to FIG. 3A. In some examples, the first sheet metal member 502 includes an unfolded post 512 and another unfolded post 514. The unfolded post 512 may be configured to be folded along at least one post fold, for example 508a and/or 510 a, thus forming a post, for example post 246 referenced in FIG. 2B. The unfolded post 514 may also be configured to be folded along at least one post fold, for example 508b and/or 510 b, thus forming a post, for example post 248 as referenced in FIG. 2B. Similarly, the second sheet metal member 504 may include an unfolded post 516 and an unfolded post 518. The unfolded post 516 may be configured to be folded along at least one post fold, for example 508c and/or 510c, thus forming a post, for example post 252 referenced in FIG. 2B. The unfolded post 518 may also be configured to be folded along at least one post fold, for example 508d and/or 510d, thus forming a post, for example post 254 referenced in FIG. 2B.

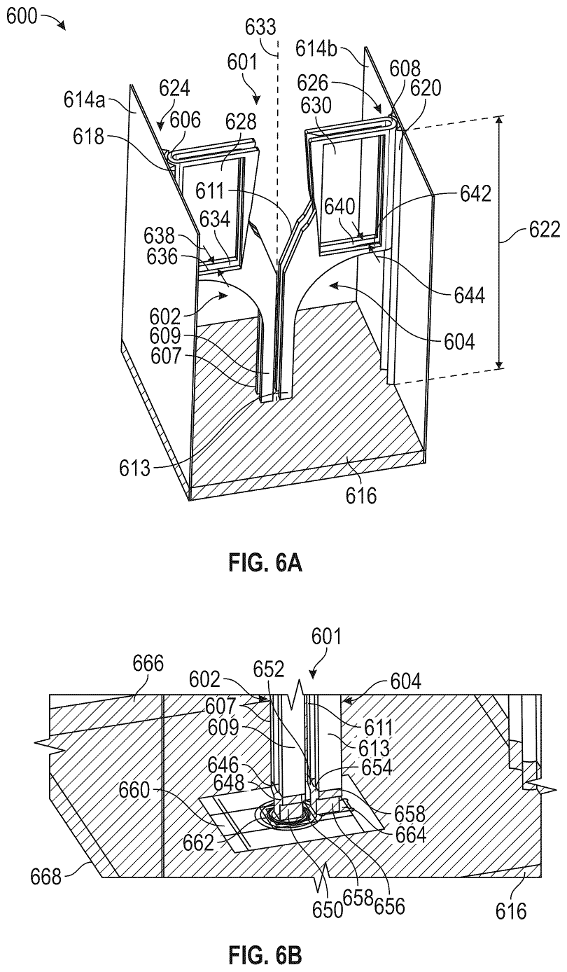

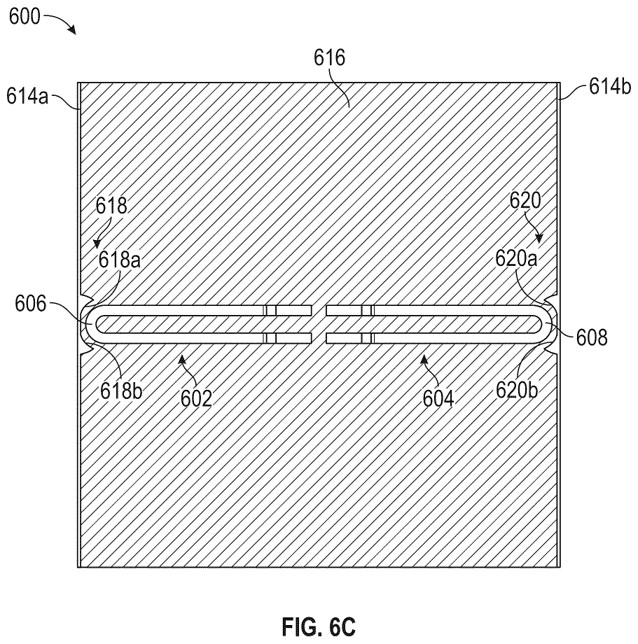

Once folded, the sheet metal members 502 and 504 may be used as a radiating element of a phased array antenna. For instance, the first sheet metal member 502 may be folded to form a first folded metal member with a connecting portion orthogonal to a base plate, and the first folded metal member may be a signal member, such that it may be electrically connected to a signal feed line on a PCB. The second sheet metal member 504 may be folded to form a second folded metal member with a connecting portion also orthogonal to the base plate, and the second folded metal member may be a ground member, such that it may be electrically connected to ground via the base plate or a ground line on a PCB. FIG. 6A illustrates aspects of a phased array antenna 600 that includes a base plate 616 and at least one radiating element 601 projecting outwardly from the base plate 616, the radiating element 601 including folded metal members with connecting portions extending orthogonally to the base plate. The radiating element 601 may be formed by folding the unfolded radiating element 500 of FIG. 5.

In some examples, the radiating element 601 includes a first folded metal member 602 spaced apart from a second folded metal member 604. In some examples, the first folded metal member 602 and the second folded metal member 604 are formed from and/or include any metal, including the examples described herein. The first folded metal member 602 may be formed by folding a sheet metal member, for example the first (or second) sheet metal members 502 (or 504) referenced in FIG. 5, along at least one fold. The first folded metal member 602 may include at least one fold 606. The fold 606 may extend orthogonal to the base plate 616. A connecting portion 624 may include the fold 606, or may be formed by part of the fold 606, and the connecting portion 624 may connect a first projecting portion 607 and a second projecting portion 609. The first projecting portion 607 and the second projecting portion 609 may project outwardly from the base plate 616. The first projecting portion 607 may include a surface 634 positioned adjacent to and facing a surface 636 of the second projecting portion 609. The first projecting portion 607 and the second projecting portion 609 may be spaced apart by a distance 638.

The second folded metal member 604 may also be formed by folding a sheet metal member, for example the first (or second) sheet metal member 502 (or 504) referenced in FIG. 5, along at least one fold. In some examples, the second folded metal member 604 may be symmetrical to folded metal member 602 about axis 633. In some examples, the second folded metal member 604 may not be symmetrical to folded metal member 602 about axis 633. In some examples, the second folded metal member 604 may have different characteristics than the first folded metal member 602, for example the second folded metal member 604 may have a different size, outline (e.g., edges), folds, etc. The second folded metal member 604 may include at least one fold 608. The fold 608 may extend perpendicular to the base plate 616. A connecting portion 626 may include the fold 608, or may be formed by part of the fold 608, and the connecting portion 626 may connect a first projecting portion 611 and a second projecting portion 613. The first projecting portion 611 and the second projecting portion 613 may project outwardly from the base plate 616. The first projecting portion 611 may include a surface 640 positioned adjacent to and facing a surface 642 of the second projecting portion 613. The first projecting portion 611 and the second projecting portion 613 may be spaced apart by a distance 644. The distance 644 may be the same as the distance 638. The distance 638 and the distance 244 may be associated with the operational frequency range and/or the electrical performance of the phased array antenna 600.

The first folded metal member 602 (e.g., the signal member) may be electrically connected to a signal feed line, and the second folded metal member 604 (e.g., the ground member) may be electrically connected to the base plate 616 or a ground line. In some examples, the first folded metal member 602 (e.g., the first signal member) may be electrically connected to a first signal feed line, and the second folded metal member 604 (e.g. the second signal member) may be electrically connected to a second signal feedline, thus forming a differential phased array antenna. FIG. 6B illustrates additional detail of the electrical connection of the first folded metal member 602 and the second folded metal member 604. The first projecting portion 607 of the first folded metal member 602 may include a post 646 and the second projecting portion 609 may include post 648. Post 646 of the first projecting portion 607 and post 648 of the second projecting portion 609 may folded together to form a mounting portion 650. In some examples, post 646 and post 648 may be folded together and then soldered to form the mounting portion 650. In some examples, the mounting portion 650 may be an attachment mechanically and electrically connected (e.g., via soldering, friction fitting, welding, etc.) to post 646 and post 648. The mounting portion 650 (and/or post 646 and post 648) of the first folded metal member 602 (e.g., the signal member) may be electrically isolated from the base plate 616 and may extend via an aperture 658 from a first side 666 of the base plate 616 to a second side 668 of the base plate 616 to electrically connect to the signal feedline 662. The signal feed line 662 may be a portion of the PCB 660, and the PCB 660 may be positioned on the second side 668 of the base plate 616.

Similarly, the first projecting portion 611 of the second folded metal member 604 may include a post 652 and the second projecting portion 613 may include post 654. Post 652 of the first projecting portion 611 and post 654 of the second projecting portion 613 may folded together to form a mounting portion 656. In some examples, post 652 and post 654 may be folded together and then soldered to form the mounting portion 656. In some examples, the mounting portion 656 may be an attachment mechanically and electrically connected (e.g., via soldering, friction fitting, welding, etc.) to post 652 and post 654. The mounting portion 656 (and/or post 652 and post 654) of the second folded metal member 604 (e.g., the ground member) may extend via an aperture 658 from a first side 666 of the base plate 616 to a second side 668 of the base plate 616 to electrically connect to ground, for example via base plate 616 or via a ground line 662. The ground line 662 may be a portion of the PCB 660, and the PCB 660 may be positioned on the second side 668 of the base plate 616.

Referring back to FIG. 6A, the space (e.g., including the space defined by distance 638) between the first projecting portion 607 and the second projecting portion 609 of the first folded metal member 602 may be filled with any material transparent in the operational frequency range, for example, ROHACELL foam. Filling the distance 638 with a transparent material may improve the mechanical stability of the first folded metal member 602. Similarly, the space (e.g., including the space defined by distance 644) between the first projecting portion 611 and the second projecting portion 613 of the second folded metal member 604 may be filled with a material transparent in the operational frequency range. Filling the distance 644 with a transparent material may similarly improve the mechanical stability of the second folded metal member 604.

The first folded metal member 602 may have a cutout 628, and the second folded metal member 604 may have a cutout 630. Cutouts 628 and 630 may have any characteristics of cutouts described herein, for example the characteristics described in reference to cutout 228 and 230 illustrated in FIG. 2A. In some examples, the fold 606 and/or the connecting portion 624 defines a capacitive coupling portion of the first folded metal member 602, and the fold 608 and/or the connecting portion 626 defines a capacitive coupling portion of the second folded metal member 604. The capacitive coupling portions of the first folded metal member 602 and the second folded metal member 604 may capacitive couple to adjacent conductive members via at least one surface. FIG. 6C illustrates aspects of the capacitive coupling portion of the first folded metal member 602 that may capacitively couple to at least one surface, for example surface 618a and surface 618b, of a capacitive coupling portion 618 of a conductive element 614a. Similarly, the capacitive coupling portion of the second folded metal member 604 may capacitively couple to at least one surface, for example surface 620a and surface 620b, of a capacitive coupling portion 620 of a conductive element 614b.

The conductive elements 614a and 614b may separate (e.g., be positioned between) adjacent radiating elements 601 and may have any characteristics of conductive elements described herein, for example as described in reference to FIGS. 2A and 2B. Similarly, the capacitive coupling portion 618 of the conductive element 614a and the capacitive coupling portion 620 of the conductive element 614b may have any characteristics of capacitive coupling portions of conductive elements described herein, for example as described in reference to FIGS. 2A and 2B. Referring back to FIG. 6A, the capacitive coupling portion 618 and the capacitive coupling portion 620 of conductive elements 614a and 614b, respectively, may also have a length 622.

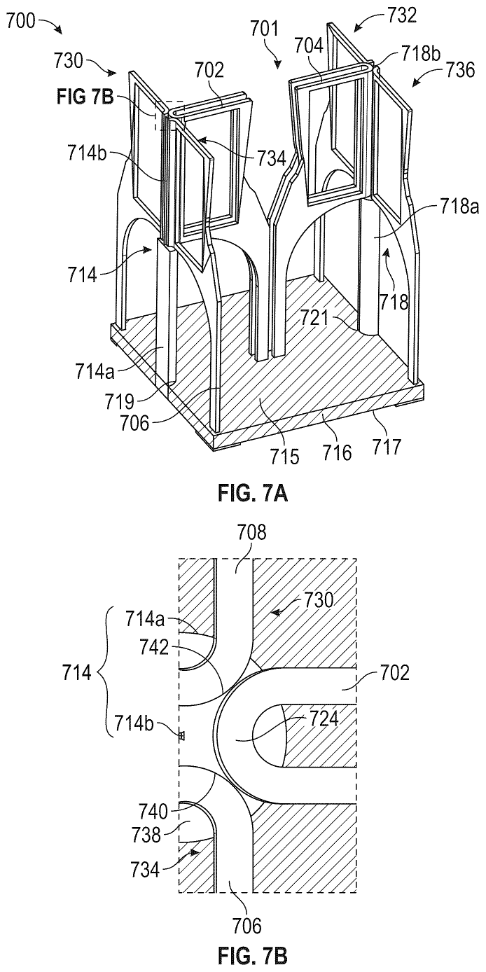

FIG. 7A illustrates exemplary aspects of another phased array antenna 700 in which a plurality of radiating elements are arranged in a dual-polarized configuration and configured to capacitively couple with one another and one of a plurality of conductive elements (e.g., grounded pillars) positioned adjacent to subsets of the radiating elements. The phased array antenna 700 includes a base plate 716 and a plurality of radiating elements, including radiating elements 701, 730, 732, 734, and 736. The radiating element 701 may include a first folded metal member 702 spaced apart from a second folded metal member 704. The first folded metal member 702 and the second folded metal member 704 may include any of the characteristics of the folded metal members described herein. The first folded metal member 702 may be a signal member and may include any of the characteristics described herein of signal members. The second folded metal member 704 may be a ground member and may include any of the characteristics described herein of ground members.

As discussed with reference to FIGS. 2A-2D and 6A-6C, the phased array antennas disclosed herein may include conductive elements (e.g., 614a and 614b) configured to capacitively couple with the radiating elements. The conductive elements are depicted in FIGS. 2A-2D and 6A-6C as substantially rectangular. However, the conductive elements disclosed herein may have any shape. For instance, the conductive elements may be cylindrical, semi-cylindrical, star-shaped, etc. For instance, FIG. 7A illustrates aspects of a phased array antenna 700 that includes conductive elements 714 and 718 configured to capacitively couple to a radiating element 701 and other adjacent radiating elements, respectively. For instance, the conductive element 714 may be configured and shaped such that radiating elements 730 and 734 (cross-sections of which are illustrated in FIG. 7A), oriented orthogonally to radiating element 701 and adjacent to folded metal member 702 can capacitively couple to conductive element 714. The conductive element 718 may be configured and shaped such that radiating elements 732 and 736 (cross-sections of which are illustrated in FIG. 7A), oriented orthogonally to radiating element 701 and adjacent to folded metal member 704 can capacitively couple to conductive element 718.

The conductive element 714 may include a first portion 714a and a second portion 714b. The first portion 714a may extend through the aperture 719 from the first side 715 of the base plate 716 to the second side 717 of the base plate 716 and may be electrically connected to ground, for example via base plate 716 or via connection to a ground line of a PCB. Although depicted as a half-cylinder, the first portion 714a may be any shape. The second portion 714b may also be any shape and may be smaller in size (e.g., have a smaller diameter) than the first portion 714a. The first portion 714a and the second portion 714b may be formed via subtractive or additive manufacturing described herein and may be formed from any metal, including the examples described herein. A height of the first portion 714a and a height of the second portion 714b may be such that the height of the conductive element 714 is greater than or equal to the height of radiating elements (e.g., radiating element 701). The height of the first portion 714a and the height of the second portion 714b may be such that the height of the conductive element 714 is less than or equal to the height of radiating elements. The conductive element 718 may also include a first portion 718a and a second portion 718b. The first portion 718a and the second portion 718b may have any of the characteristics described above for the first portion 714a and the second portion 714b, respectively.

The conductive elements 714 and 718 may capacitively couple to adjacent radiating elements via capacitive coupling portions on the radiating elements. FIG. 7B illustrates a detail view of aspects of the capacitive coupling portion of the first folded metal member 702 of radiating element 701, a folded metal member 706 of radiating element 734, a folded metal member 708 of radiating element 730, and the conductive element 714. The first folded metal member 702 of the radiating element 701 may include a capacitive coupling portion 724, and the capacitive coupling portion 724 may include the fold, or part of the fold, formed by folding a sheet metal member into the first folded metal member 702. The first folded metal member 706 of radiating element portion 730 may a capacitive coupling portion 740 (a section of which is depicted in FIG. 7B), and the capacitive coupling portion 740 may include the fold formed by folding a sheet metal member into the first folded metal member 706. The second folded metal member 708 of the radiating element 734 may include a capacitive coupling portion 742 (a section of which is depicted in FIG. 7B), and the capacitive coupling portion 742 may include the fold formed by folding a sheet metal member into the second folded metal member portion 708.

The first folded metal member 702 may capacitively couple via the capacitive coupling portion 724 to the capacitive coupling portion 740 of the folded metal member 706 and/or to the capacitive coupling portion 742 of the second folded metal member 708. The first portion 714a of the conductive element 714 may include a surface 738. The surface 738 may capacitively couple to capacitive coupling portion 724, to the capacitive coupling portion 740, and/or to the capacitive coupling portion 742. The second portion 714b of the conductive element 714 may itself be a capacitive coupling portion and may capacitively couple to the capacitive coupling portion 724, to the capacitive coupling portion 740, and/or to the capacitive coupling portion 742. A person of skill in the art would appreciate that the capacitive coupling portions of the second folded metal member 704, radiating elements 732 and 736, and the conductive element 718 may be symmetric to the capacitive coupling portion 724 of the first folded metal member 702, the capacitive coupling portions of radiating elements 730 and 734, and the conductive element 714, respectively.

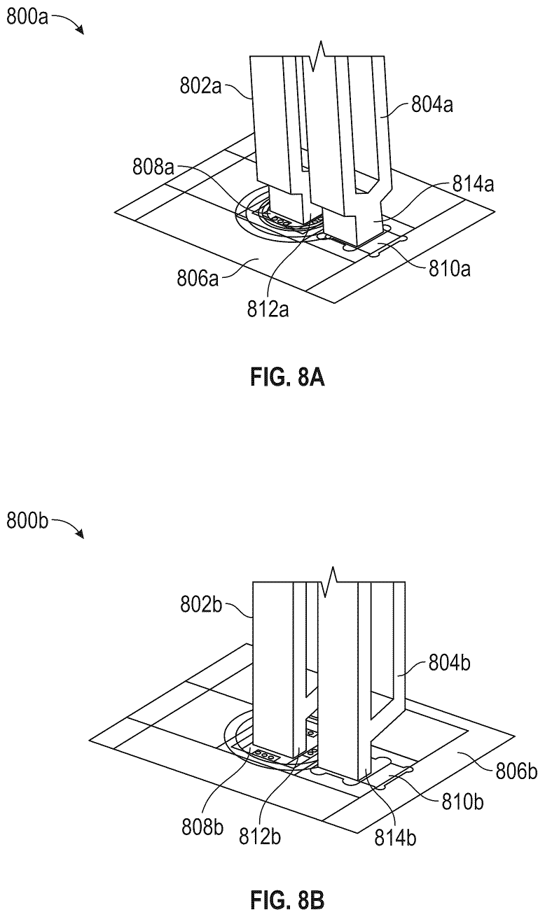

FIG. 8A illustrates a first exemplary view 800a of a first folded metal member 802a (e.g., signal member) and a second folded metal member 804a (e.g., ground member) electrically connected to a PCB 806a via mounting portions of the folded metal members. For instance, the first folded metal member 802a may be the first folded metal member 602 (e.g., signal member) electrically connected to a signal feedline 662 on PCB 660 via the mounting portion 650 in FIG. 6B, and the second folded metal member 804a may be the second folded metal member 604 (e.g., ground member) electrically connected to ground line 664 on PCB 660 via the mounting portion 656 in FIG. 6B.. In some examples, the PCB 806a includes a signal feed line connector 808a and an electrical ground connector 810a. The mounting portion 812a of the first folded metal member 802a may be connected to the signal feed line connector 808a on PCB 806a. The mounting portion 812a of the first folded metal member 802a may contact the PCB 806a and/or be connected to the PCB 806a via any attachment method, for example soldering, gluing, slotting into an adaptor. The mounting portion 814a of the second folded metal member 804a may be connected to the electrical ground connector 810a on PCB 806a. The mounting portion 814a of the second folded metal member 804a may also contact the PCB 806a and/or be connected to the PCB 806a via any attachment method, including the examples described herein. In some examples, the connections of the first 802a and second folded metal members 804a are reversed, such that the mounting portion 812a of the first folded metal member 802a is connected to electrical ground 810a and the mounting portion 814a of the second folded metal member 804a is connected to the signal feed line 808a. In some examples, the PCB 806 a may be attached to the bottom of any base plate described herein. The PCB 806a may be attached via any attachment method, including the examples described herein.

FIG. 8B illustrates a second exemplary view of a first folded metal member 802b (e.g., signal member) and a second folded metal member 804b (e.g., ground member) electrically connected to a PCB 806b via mounting portions of the folded metal members. For instance, the first folded metal member 802b may be the first folded metal member 602 (e.g., signal member) electrically connected to a signal feedline 662 on PCB 660 via the mounting portion 650 in FIG. 6B, and the second folded metal member 804b may be the second folded metal member 604 (e.g., ground member) electrically connected to ground line 664 on PCB 660 via the mounting portion 656 in FIG. 6B.. In some examples, the PCB 806b includes a signal transmission feedline connection 808b and an electrical ground connection 810b. The mounting portion 812b of the first folded metal member 802b may be attached to the signal transmission feedline connection 808b on PCB 806b. The mounting portion 812b of the first folded metal member 802b may contact the PCB 808b and/or be connected to the PCB 806b via any attachment means described herein. The mounting portion 814b of the second folded metal member 804b may be attached to the electrical ground connection 810b on PCB 806b. The mounting portion 814b of the second folded metal member 804b may contact the PCB 806b and/or be connected to the PCB 806b via any attachment method, including the examples described herein. In some examples, the connections of the first 802b and second folded metal members 804b are reversed, such that the mounting portion 812b of the first folded metal member 802b is connected to electrical ground 810b and the mounting portion 814b of the second folded metal member 804b is connected to the signal transmission feed line 808b. In some examples, the PCB 806 b may be attached to the bottom of any base plate described herein. The PCB 806b may be attached via any attachment method, including the examples described herein.

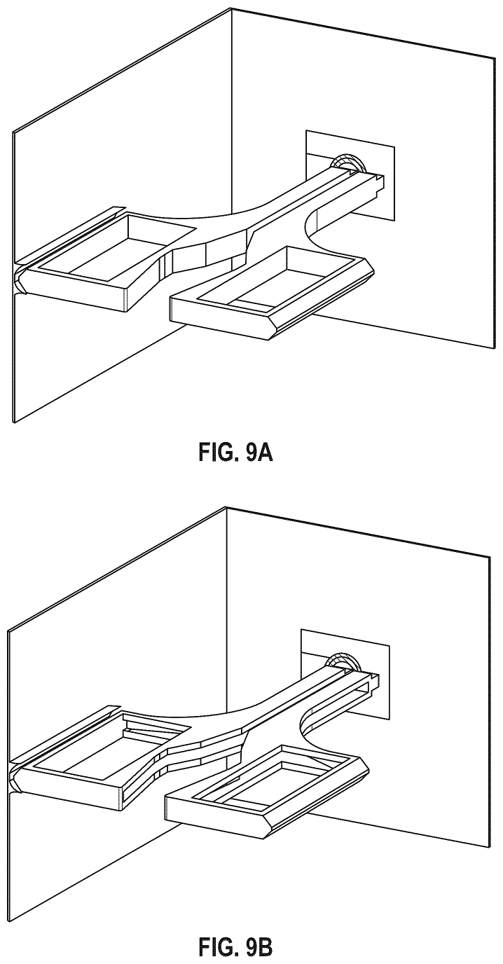

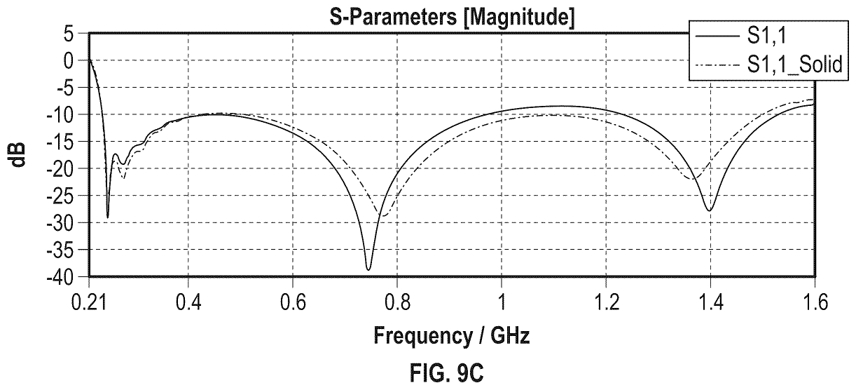

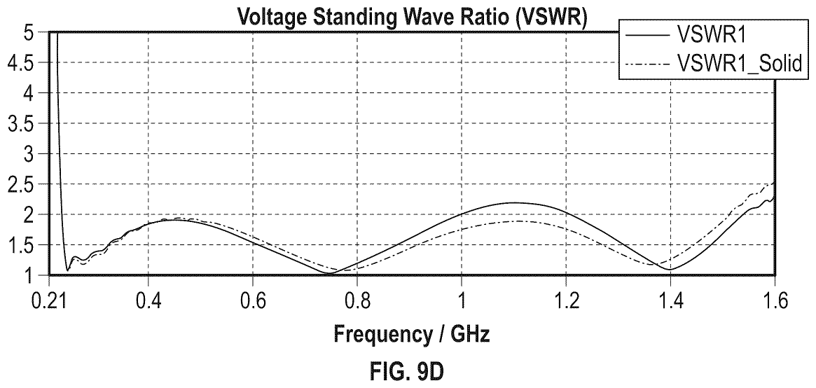

Compared to phased array antennas that include radiating elements formed via casting or milling, the phased array antenna disclosed herein may be a more lightweight, scalable, and cost-efficient design and may additionally exhibit similar electrical performance. FIG. 9A illustrates a phased array antenna including a base plate and a radiating element, in which the radiating element includes a first solid metal member (e.g., signal member) and a second solid metal member (e.g., ground member) that may be formed via casting or milling. FIG. 9B illustrates a phased array antenna including a base plate and a radiating element, in which the radiating element includes a first folded metal member (e.g., signal member) and second folded metal member (e.g., ground member), as described herein. FIG. 9C is a plot of the signal power loss, measured as the S11 amplitude, of the phased array antenna of FIG. 9A (e.g., dashed line in FIG. 9C) and the phased array antenna of FIG. 9B (e.g., solid line in FIG. 9C). FIG. 9C illustrates that the phased array antenna disclosed herein (e.g., phased array antenna of FIG. 9B) has similar electrical performance as the phased array antenna of FIG. 9A. FIG. 9D is a plot of the signal power loss, measured as the voltage standing wave ratio (VSWR), for the phased array antenna in FIG. 9A (e.g., dashed line in FIG. 9D) and the phased array antenna in FIG. 9B (e.g., solid line in FIG. 9D). Similarly, FIG. 9D illustrates that the phased array antenna disclosed herein (e.g., phased array antenna of FIG. 9B) has similar electrical performance as the phased array antenna of FIG. 9A.

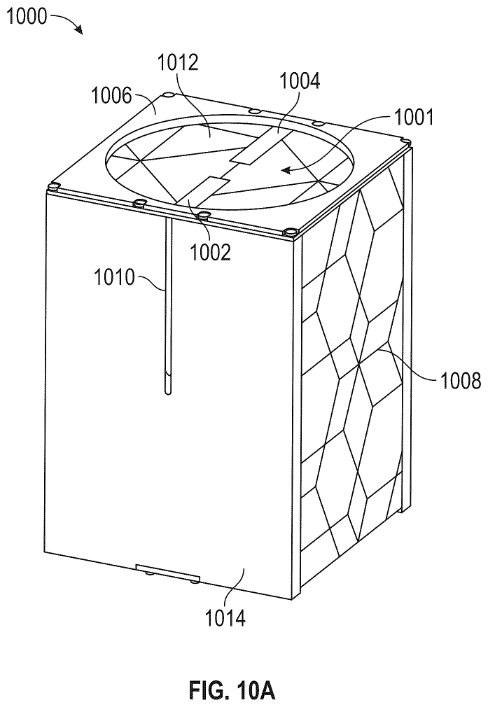

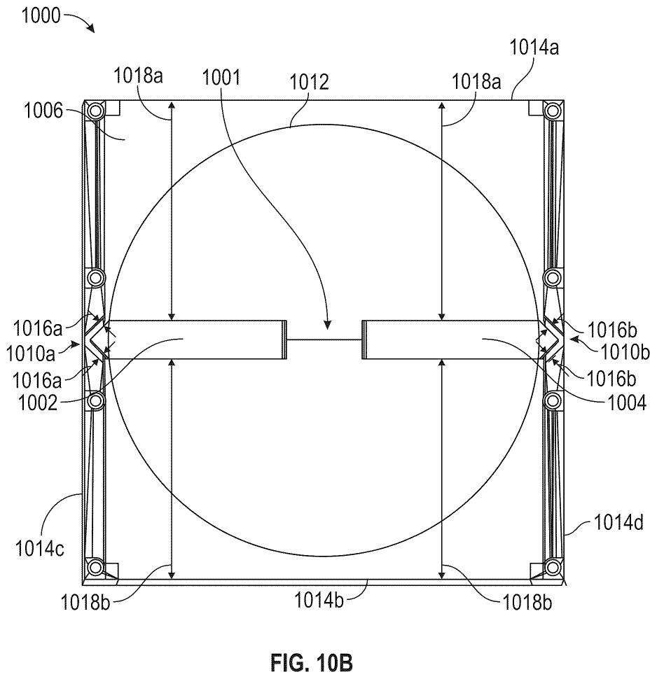

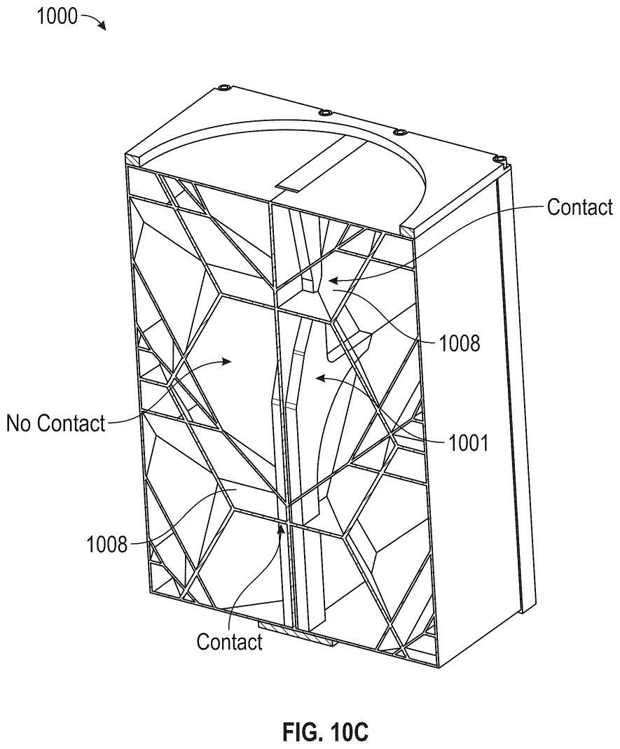

In some examples, the folded metal members may be supported via a support structure to reduce (e.g., minimize) vibration of the folded metal members during operation and/or during transport (e.g., during launch of a satellite into orbit). The support structure may have a relatively low solid volume (e.g., may be mostly hollow) to maintain the lightweight design of the phased array antenna. FIG. 10A illustrates a first view of a support structure 1000 configured to structurally support at least one radiating element 1001, which may be any radiating element described herein, for example radiating element 201 of FIGS. 2A-2D, radiating element 601 of FIGS. 6A-6C, or radiating element 701 of FIG. 7A. In some examples, the at least one radiating element 1001 includes a first folded metal member 1002 and a second folded metal member 1004. The support structure 1000 may be any material transparent in the operational frequency range of a phased array antenna, as described in reference to FIG. 2A, and the support structure 1000 may be fabricated by any subtractive manufacturing method described herein and/or additive manufacturing method, for example multijet 3D printing, polyjet 3D printing, vat photopolymerization, material jetting, binder jetting, material extrusion, powder bed fusion, sheet lamination, or directed energy deposition. In some examples, the support structure may be molded (e.g., injection molding, compression molding, extrusion molding, etc.) or formed according to any other suitable manufacturing method. The support structure 1000 may include at least one wall, for example wall 1014. The at least one wall 1014 may be or include any material transparent in the operational frequency range of a phased array antenna and may be solid or hollow. The at least one wall 1014 may include a cutout 1010. The cutout 1010 may be a hole in a transparent material used to form wall 1014. In some examples, the radiating element 1001 capacitively couples to an adjacent radiating element, a post, or a conductive element via the cutout 1010. The cutout 1010 may be formed by any subtractive manufacturing method described herein, by designing the cutout into any additive manufacturing method described herein, or by any other suitable manufacturing method. The cutout 1010 may be any shape, for example an arcuate or geometric shape.

In some examples, the at least one wall 1014, and thus the support structure 1000, may be separated from the radiating element 1001. FIG. 10B illustrates aspects of a second view of the support structure 1000 configured to structural support the at least one radiating element 1001. For example, wall 1014a may be separated from the first folded metal member 1002 and the second folded metal member 1004 by a distance 1018a. Similarly, wall 1014b may be separated from the first folded metal member 1002 and the second folded metal member 1004 by a distance 1018b, which may or may not be the same distance as 1018a. Additionally, wall 1014c may include a cutout 1010a, and the first folded metal member 1002 may be positioned adjacent to and spaced apart from, for example by distance 1016a, the cutout 1010a. Wall 1014d may include a cutout 1010b, and the second folded metal member 1004 may be positioned adjacent to and spaced apart from, for example by distance 1016b, the cutout 1010b. Although FIG. 10B depicts a square support structure 1000 with four walls, a person of skill in the art will appreciate the support structure 1000 may be any shape (e.g., an arcuate or geometric shape) with any number of walls.

Referring back to FIG. 10A, in some examples, the support structure 1000 includes a top 1006. The top 1006 may be secured to the at least one wall 1014 with any attachment method (e.g., screws, pins, etc.), including the examples described herein. In some examples, the top 1006 is separated from the radiating element 1001 by a gap (not shown in FIG. 10A or FIG. 10B). The top may be solid or hollow and may also include a cutout 1012. The cutout 1012 may mitigate disruption in signal transmission and signal reception of a phased array antenna and may simultaneously reduce the weight of the support structure 1000. The cutout 1012 may be formed by any subtractive manufacturing method described herein and/or designing the cutout into any additive manufacturing method described herein. The cutout 1012 may be any shape, for example an arcuate shape, circular shape, or other geometric shape.

The support structure 1000 may include support ribs 1008, and the support ribs 1008 may provide additional support to the at least one radiating element 1001. In some examples, the support ribs 1008 are integral to the support structure 1000. In some examples, the support ribs 1008 are fabricated separately and then attached to the inside of the support structure 1000 via any attachment method, such as by gluing, soldering, using mechanical fasteners, etc. In some examples, the support ribs 1008 are fabricated separately and then added to the inside of the support structure without attaching to the support structure 1000. The support ribs 1008 may be fabricated by any subtractive and/or additive manufacturing method described herein. The support ribs 1008 may be any shape and/or pattern, for example a lattice as depicted in FIG. 10A. In some examples, the support ribs 1008 touch the radiating element 1001. In some examples, the support ribs 1008 do not touch the radiating element 1001. The support ribs 1008 may contact sections of the radiating element 1001 to provide structural support. In some examples one or more portions of the support ribs are shaped to enclose a respective portion of the radiating element. FIG. 10C illustrates a section view showing examples of how portions of the support ribs 1008 of support structure 1000 depicted in FIGS. 10A and 10B may at least partially enclose portions of the radiating element 1001, while other portions of the support ribs 1008 may be spaced apart from the radiating element 1001.

The support structure may be manufactured such that it is minimally massive while maintaining structural support for the radiating element(s). In some examples, the support structure 1000 has a solid volume in a range of 1% to 25% of the overall volume of the support structure 1000, for example 1%, 5%, 10%, 15%, 20%, or 25%. In some examples, the support structure 1000 has a solid volume greater than or equal to 1%, 5%, 10%, 15%, 20%, or 25% of the overall volume of the support structure 1000. In some examples, the support structure 1000 has a solid volume less than or equal to 1%, 5%, 10%, 15%, 20%, or 25% of the overall volume of the support structure 1000. The support structure may be formed from a material with volumetric density relative to the volume of the unit cell of at most 1%, at most 5%, at most 10%, at most 15%, at most 20%, or at most 25%. In some examples, the support ribs 1008 are included in the solid volume of the support structure 1000. In some examples, the support structure 1000 includes at least one additional cutout or slot. The at least one additional cutout or slot may be used to connect various components to the phased antenna array, for example the at least one additional cutout or slot may be used to connect a PCB.

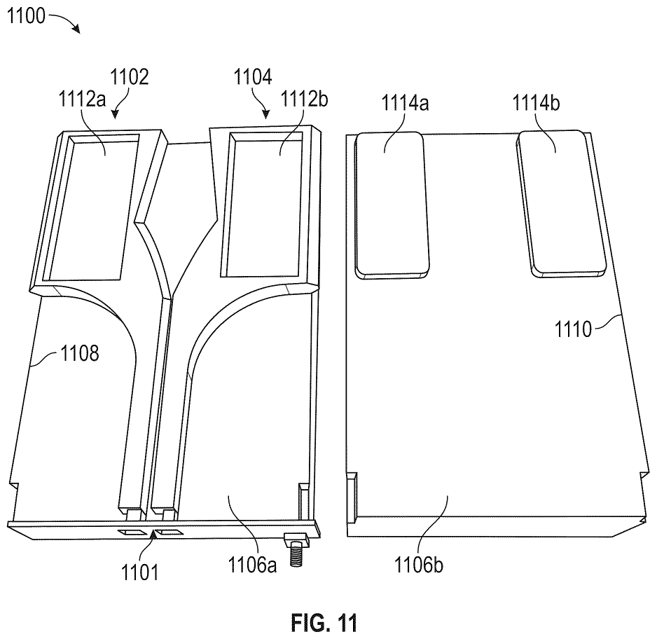

FIG. 11 illustrates an exemplary support structure 1100 configured to structurally support at least one radiating element 1101. Support structure 1100 may reduce (e.g., minimize) vibrations of the at least one radiating element 1101 during operation of the at least one radiating element 1101 and/or during transport, such as during a launch of a satellite into orbit. The at least one radiating element 1101 may be any radiating element described herein, for example radiating element 201 of FIGS. 2A-2D, radiating element 601 of FIGS. 6A-6C, or radiating element 701 of FIG. 7A. In some examples, the at least one radiating element 1101 includes a first folded metal member 1102 and a second folded metal member 1104. The first folded metal member 1102 may be any first folded metal member described herein, such as first folded metal member 202 of FIG. 2A-2C. The second folded metal member 1104 may be any second folded metal member described herein, such as second folded metal member 204 of FIG. 2A-2C.

The support structure 1100 may include one or more surfaces positioned in contact with the radiating element 1102. The one or more surfaces may add structural support to radiating element 1101 to reduce (e.g., minimize) vibrations of the radiating element 1101 during operation. The support structure 1100 may have a first portion 1108 and a second portion 1110, and the radiating element 1101 may be positioned at least partially between (e.g., may be sandwiched between) the first portion 1108 and the second portion 1110. For instance, radiating element 1101 may be positioned at least partially in contact with a first surface 1106a of the first portion 1108 and at least partially in contact with a second surface 1106b of the second portion 1110 via a contacting surface 1106. The first portion 1108 and the second portion 1110 may be formed from any material transparent in the operational frequency range of a phased array antenna, as described in reference to FIG. 2A. The first portion 1108 and the second portion 1110 may be fabricated by any subtractive and/or additive manufacturing method described herein. In some examples, the first portion 1108 and the second portion 1110 have a relatively low solid volume (e.g., relative to a solid support structure or foam support structure) to maintain the lightweight design of the phased array antenna, such as described in reference to FIG. 10A. For instance, the first portion 1108 and the second portion 1110 may each have a solid volume in a range of 5% to 25%, such as described in reference to FIG. 10A.

The first portion 1108 may have protruding elements 1112a and 1112b that further structurally support the radiating element 1101 by slotting into cutouts of the first folded metal member 1102 and the second folded metal member 1104, respectively (e.g., such as cutouts 228 and 230 of the first folded metal member 202 and the second folded metal member 204, respectively, of FIG. 2A). The protruding elements 1112a and 1112b may be fabricated such that they are integral to the first portion 1108 (e.g., designed into the subtractive and/or additive manufacturing of the first portion 1108). In some examples, the protruding elements 1112a and 1112b are fabricated separately from the first portion 1108 via any subtractive and/or additive manufacturing method described herein and then mechanically attached (e.g., via glueing, soldering, etc.) to the first portion 1108.

The second portion 1110 may have protruding elements 1114a and 1114b that also slot into the cutouts of the first folded metal member 1102 and the second folded metal member 1104, respectively. The protruding elements 1114a and 1114b may be fabricated such that they are integral to the second portion 1110 (e.g., designed into the subtractive and/or additive manufacturing of the second portion 1110). In some examples, the protruding elements 1114a and 1114b are fabricated separately from the second portion 1110 via any subtractive and/or additive manufacturing method described herein separately and then mechanically attached (e.g., via glueing, soldering, etc.) to the second portion 1110. The protruding elements 1112a and 1112b of the first portion 1108 and the protruding elements 1114a and 1114b of the second portion 1110 may have a height that allows the at least one radiating element 1101 to touch the contacting surface 1106 when the at least one radiating element 1101 is mounted to the protruding elements.

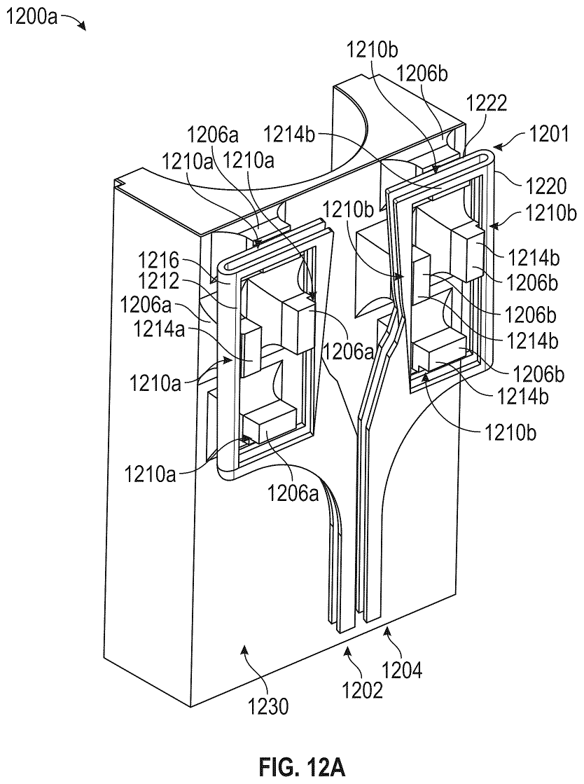

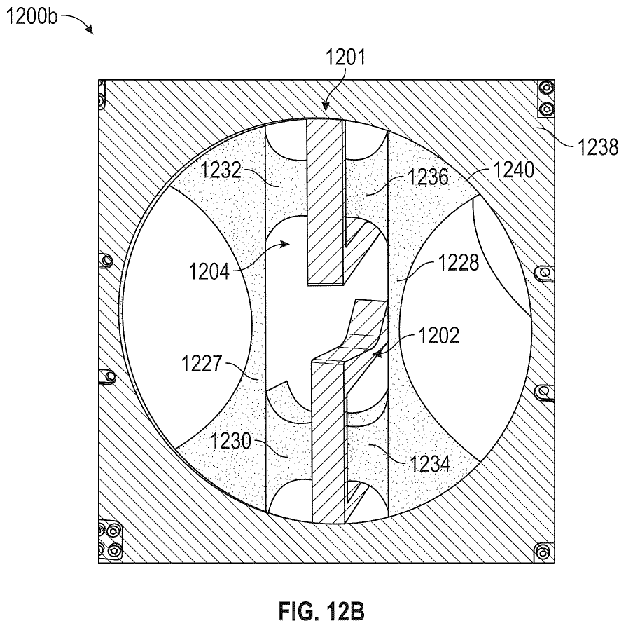

In some examples, it may be desirable to minimize contact between a support structure and the radiating elements. FIG. 12A illustrates an exemplary support structure 1200a configured to structurally support at least one radiating element 1201. Support structure 1200a may include one or more posts that extend from a surface 1220 of the support structure and contact the at least one radiating element 1201. One or more posts 1206a may be configured to support a first folded member 1202 of radiating element 1201 and one or more posts 1206b may be configured to support a second folded metal member 1204 of radiating element 1201. The posts 1206a and 1206b may be configured such that the first folded member 1202 can connect to the one or more posts 1206a and the second folded metal member 1204 can connect to the one or more posts 1206b.

The posts 1206a may each include a step 1210a configured to enable the folded metal member 1202 to slide/snap on to the posts 1206a such that a back surface 1212 of the folded metal member 1202 is flush with an outermost surface 1214a one or more of the posts 1206a and a front surface 1216 opposite the back surface 1212 of the folded metal member 1202 is offset from the surface 1230 of support member 1201. The folded metal member 1202 of radiating element 1201 may thus be positioned offset from surface 1230 of the support structure 1200a and structurally supported by the posts 1206a. The posts 1206b may each include a step 1210b configured to enable the folded metal member 1204 to slide/snap on to the posts 1206b such that a back surface 1220 of the folded metal member 1204 is flush with an outermost surface 1214b one or more of the posts 1206b and a front surface 1222 opposite the back surface 1220 of the folded metal member 1204 is offset from the surface 1230 of support member 1201. The folded metal member 1204 of radiating element 1201 may thus be positioned offset from surface 1230 of the support structure 1200a and structurally supported by the posts 1206b. Positioning the folded metal members 1202 and 1204 offset from surface 1230 may be advantageous in that may minimize interference with transmission performance (resulting from surface contact) while still providing structural support via the posts.

The at least one radiating element 1201 may be any radiating element described herein, for example radiating element 201 of FIGS. 2A-2D, radiating element 601 of FIGS. 6A-6C, or radiating element 701 of FIG. 7A. In some examples, the at least one radiating element 1201 includes a first folded metal member 1202 and a second folded metal member 1204. The first folded metal member 1202 may be any first folded metal member described herein, such as first folded metal member 202 of FIG. 2A-2C. The second folded metal member 1204 may be any second folded metal member described herein, such as second folded metal member 204 of FIG. 2A-2C.

The support structure 1200a may be fabricated by any subtractive manufacturing method described herein and/or additive manufacturing method described herein. In some examples, the support structure 1200a has a low solid volume to maintain the lightweight design of the phased array antenna, such as described in reference to FIG. 10A. For instance, the support structure may have a solid volume in a range of 1% (or below 1%) to 25%, such as described in reference to FIG. 10A. In some examples, the support structure 1200a includes a cutout 1224. The cutout 1224 may further reduce the solid volume of the support structure 1200a.

In some examples, support structure 1200a forms one half of a support structure that at least partially encloses radiating element 1201. Radiating element 1201 may be positioned between two symmetrical support structure portions that include any or all of the aspects of support structure 1200a, and the two symmetrical support structure portions may together support radiating element 1201 to reduce (e.g., minimize) vibrations during operation of the phased array antenna. FIG. 12B illustrates aspects of the at least one radiating element 1201 sandwiched between a first portion 1227 and a second portion 1228 of a support structure 1200b, each of which may include any of the features described with reference to support structure 1200a of FIG. 12A. The first portion 1227 and the second portion 1228 may mirror images of one another. The first portion 1227 may have posts 1230 and 1232 that mechanically support and latch onto the at least one radiating element 1201. Similarly, the second portion 1228 may have posts 1234 and 1236 that mechanically support and latch onto the at least one radiating element 1201. The posts 1230 and 1234 may include one or more aspects of the posts 1206a of the support structure 1200a of FIG. 12A. The posts 1232 and 1236 may include one or more aspects of the posts 1206b of the support structure 1200a of FIG. 12A.

In some embodiments, the support structure 1200b has a top 1238. The top 1238 may be secured to the first portion 1227 and/or the second portion 1228 with any attachment method, including the examples described herein. In some examples, the top 1238 is separated from the at least one radiating element 1201 by a gap (not shown in FIG. 12B). The top 1238 may be solid or hollow and may also include a cutout 1240, such as cutout 1012 of FIG. 10B. The cutout 1240 may mitigate disruption in signal transmission and signal reception of a phased array antenna and may simultaneously reduce the weight of the support structure 1200b. The cutout 1240 may be formed by any subtractive manufacturing method described herein and/or designing the cutout into any additive manufacturing method described herein. The cutout 1240 may be any shape, for example an arcuate or geometric shape.

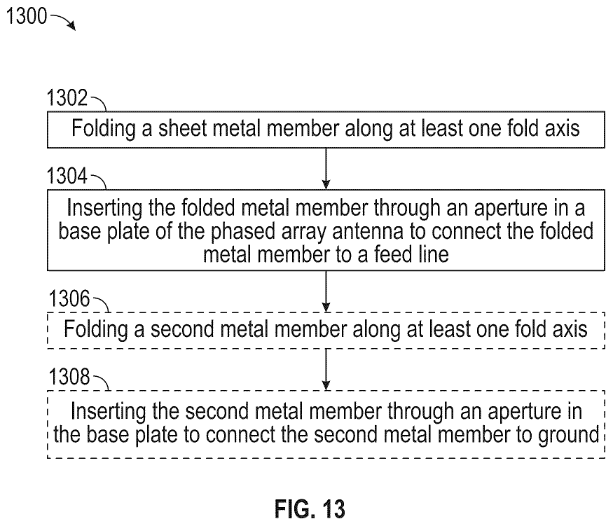

FIG. 13 illustrates an exemplary method 1300 for assembling a phased array antenna that includes radiating elements having folded metal members according to one or more of the examples disclosed herein. At block 1302, the method 1300 may include folding a sheet metal member along at least one fold. For example, a sheet metal member may be folded along fold 506a (or 506b) illustrated in FIG. 5, thus forming a folded metal member like the first (or second) folded metal member 602 (or 604) as illustrated in FIG. 6A. In some examples, a sheet metal member may be folded along folds 206 or 208, thus forming a first folded metal member 202 or a second folded metal member 204, respectively, as illustrated in FIG. 2A. In yet other examples, a sheet metal member may be folded along folds 338a and 338b (folds 438a and 438b), thus forming a folded metal member, for example folded metal member 300b (400b) illustrated in FIG. 3B (4B). A person of skill in the art would appreciate that the aforementioned are merely exemplary examples of folding a sheet metal member along at least one fold and that a folded metal member may be formed by folding a sheet metal member along any fold (or folds).

At block 1304, the method 1300 may include inserting the folded metal member through an aperture in a base plate of the phased array antenna to connect the folded metal member to a signal feed line (e.g., the folded metal member may be a signal member). In some examples, prior to inserting the metal member through the aperture, method 1100 includes folding the folded metal member (and/or the sheet metal member) along at least one additional fold to form a mounting portion. The mounting portion may be inserted through the aperture in the base plate to connect the mounting portion to a signal feed line. For example, as illustrated in FIG. 2B, a first post 246 and a second post 248 of a first folded metal member 202 may be folded together to form a mounting portion 250, and the mounting portion 250 may be inserted through the aperture 258 in the base plate 216 to connect the mounting portion 250 to the signal feed line 262. Alternatively, the folded metal member may be a ground member, such that the mounting portion may connect to a ground, for example via a base plate or a ground line on a PCB. The posts of the folded metal members may be formed by folding an unfolded post of a sheet metal member. For example, a first post 320a in FIG. 3B may be formed by folding an unfolded post, for example unfolded post 312, along at least one post fold, for example 308a and 310a (see FIG. 3A). Similarly, a second post 320b in FIG. 3B may be formed by folding another unfolded post, for example unfolded post 314, along at least one post fold, for example 308c and 310 c (see FIG. 3A). In yet other examples, a first post 420a in FIG. 4B may be formed by not folding an unfolded post, for example unfolded post 414 (see FIG. 4A). Conversely, the second post 420b in FIG. 4B may be formed by folding another unfolded post, for example unfolded post 312, along at least one post fold, for example 408a and 410 a (see FIG. 4A).

In some examples, the method 1300 may include folding the sheet metal member (or folded metal member) along at least one additional fold to form a capacitive coupling portion. For example, as illustrated in FIG. 2D, a capacitive coupling portion 215 may be formed by folding a conductive tab 210a along fold 212a and folding a conductive tab 210b along fold 212b. In some examples, most clearly illustrated in FIG. 7C, the fold 724 of a first folded metal member 702 may itself be a capacitive coupling portion. In some examples, the capacitive coupling portion may be integral to the sheet metal member (or folded metal member). In some examples, the capacitive coupling portion may be electrically joined and attached to the sheet metal member (or folded metal member) via welding, conductive adhesive, soldering, etc.

At block 1306, the method 1300 may include folding a second metal member along at least one fold. A person of skill in the art would appreciate that the aforementioned, for example in reference to block 1302, are merely exemplary examples of folding a sheet metal member along at least one fold and that a second folded sheet metal member may be formed by folding the second sheet metal member along any fold (or folds). In some examples, a now first folded metal member and the second folded metal member of the phased array antenna are symmetric, for example, as illustrated in FIG. 2A, a first folded metal member 202 and a second folded metal member 204 are symmetric about an axis 233. In some examples, the first folded metal member and the second folded member are not symmetric. In yet other examples, the second folded metal member has different characteristics than the first folded metal member, for example the second folded metal member may have a different size, outline (e.g., edges), folds, etc.

At block 1308, the method 1300 may include inserting the second folded metal member through an aperture in the base plate to connect the second folded metal member to ground. In some examples, prior to inserting the second folded metal member through the aperture, method 1300 includes folding the second folded metal member (and/or the second sheet metal member) along at least one additional fold to form a mounting portion. The mounting portion may be inserted through the aperture in the base plate to connect the mounting portion to ground. For example, as illustrated in FIG. 2B, a first post 252 and a second post 254 of a second folded metal member 204 form a mounting portion 256, and the mounting portion 256 may be inserted through the aperture 258 in the base plate 216 to connect the mounting portion 256 to a ground line 264 on PCB 260. Alternatively, the second folded metal member may be a second signal member, such that the mounting portion may be electrically connected to a second signal feed line. The first folded metal member and the second folded metal member may thus form a differential pair of a differential phased array antenna. The posts of the folded metal members may be formed by folding an unfolded post of a sheet metal member, as described herein. In some examples, the method 1300 may include folding the second sheet metal member (or second folded metal member) along at least one additional fold to form a capacitive coupling portion. The capacitive coupling portion of the second sheet metal member (or second folded metal member) may have any of the characteristics described herein for the capacitive coupling portion of the first sheet metal member (or first folded metal member).

1. A phased array antenna comprising:
a base plate; and
at least one radiating element projecting outwardly from the base plate and comprising a folded metal member.

2. The phased array antenna of claim 1, wherein at least one fold of the folded metal member extends orthogonally to the base plate.

3. The phased array antenna of claim 1, wherein at least one fold of the folded metal member extends parallel to the base plate.

4. The phased array antenna of claim 1, comprising a conductive element projecting outwardly from the base plate and configured to capacitively couple to the folded metal member.

5. The phased array antenna of claim 4, wherein a capacitive coupling portion of the conductive element has a shape that corresponds to a shape of a capacitive coupling portion of the folded metal member and is spaced apart from the capacitive coupling portion of the folded metal member by a gap.

6. The phased array antenna of claim 4, wherein at least one surface of the capacitive coupling portion of the folded metal member is parallel to at least one surface of the capacitive coupling portion of the conductive element.

7. The phased array antenna of claim 1, wherein the folded metal member is electrically isolated from the base plate.

8. The phased array antenna of claim 1, wherein the folded metal member comprises a connecting portion that extends within an aperture in the base plate and is configured to electrically connect to a signal line.

9. The phased array antenna of claim 1, wherein the folded metal member is a first folded metal member and the first radiating element comprises a second folded metal member spaced apart from the first folded metal member.

10. The phased array antenna of claim 9, wherein the second folded metal member is electrically connected to the base plate.

11. The phased array antenna of claim 1, comprising a second radiating element projecting outwardly from the base plate and oriented orthogonally to the first radiating element.

12. The phased array antenna of claim 1, wherein the first folded metal member comprises:
a first projecting portion extending from the base plate;
a second portion extending parallel to the first projecting portion and spaced apart from a first portion; and
a connecting portion that joins the first projecting portion and the second projecting portion, the connecting portion comprising at least one fold.

13. The phased array antenna of claim 12, wherein the connecting portion extends parallel to the base plate.

14. The phased array antenna of claim 12, wherein the connecting portion extends orthogonally to the base plate.

15. The phased array antenna of claim 12, wherein the connecting portion forms an arcuate shape.

16. The phased array antenna of claim 12, wherein the connecting portion is orthogonal to the first projecting portion and the second projecting portion.

17. The phased array antenna of claim 1, comprising a support structure configured to structurally support the folded metal member, wherein the support structure comprises a plurality of support ribs configured to support the folded metal member.

18. A method of assembling a phased array antenna, the method comprising:
folding a metal member along at least one fold; and
mounting the first metal member to a base plate of the phased array antenna.

19. The method of claim 18, comprising: folding the metal member along at least one additional fold to form a capacitive coupling portion; folding the metal member along at least one additional fold to form a mounting portion; and inserting the mounting portion through the aperture in the base plate to connect the mounting portion to the feed line.

20. The method of claim 18, comprising: folding a second metal member along at least one fold; and mounting the second metal member to the base plate, wherein the first metal member and the second metal member form a radiating element.
